(19) United States
(12) Patent Application Publication
(10) Pub. No.: US 2024/0187262 A1
(43) Pub. Date: Jun. 6, 2024

(54) ENCRYPTED AND AUTHENTICATED FIRMWARE PROVISIONING WITH ROOT-OF-TRUST BASED SECURITY

(71) Applicant: CRYPTO QUANTIQUE LIMITED, LONDON (GB)

(72) Inventors: Marcel Armour, London (GB); Charles Grover, London (GB); Shahram Mossayebi, London (GB)

(73) Assignee: CRYPTO QUANTIQUE LIMITED, London (GB)

(21) Appl. No.: 18/553,015

(22) PCT Filed: Apr. 12, 2022
(86) PCT No.: PCT/GB2022/050910

§ 371 Date: Sep. 28, 2023

(30) Foreign Application Priority Data
Apr. 12, 2021 (GB) 2105203.0

(51) Int. Cl. H04L 9/32; H04L 9/30

(52) U.S. Cl. CPC H04L 9/3278; H04L 9/3073; H04L 9/3247

(57) ABSTRACT

Methods, apparatuses, devices and computer readable media are provided in relation to firmware encryption. In one example, a method is provided, the method for providing firmware to an electronic device. The electronic device comprises a security module having a physical unclonable function (PUF), the security module configured to establish a firmware key pair (FPK, FSK) based on a challenge and response to the PUF, the firmware key pair comprising a firmware public key (FPK) and a firmware secret key (FSK). The method comprises causing a hash of the firmware to be signed using a secret key of a key pair to obtain a signature over the hash, the key pair comprising a public key and the secret key, wherein the public key is embedded securely in the electronic device. The method further comprises encrypting the firmware and the signature over the hash using a server encryption key. The method further comprises encrypting a server decryption key using the FPK, the server decryption key for decrypting the encrypted firmware and the encrypted signature. The method further comprises communicating the encrypted firmware, the encrypted signature, and the encrypted server decryption key to a third party for installation on the electronic device.

### TECHNICAL FIELD

The present disclosure relates generally to methods and systems for establishing trust between parties. In particular, the present disclosure relates to methods for securely providing firmware to an electronic device and the computing apparatuses configured to perform such methods. The disclosure herein is applicable to many devices and networks, but is particularly applicable to internet connected devices.

### BACKGROUND

Networks such as the Internet have changed the way that everyday tasks are carried out, and this has had major implications for information security. Many everyday tasks require digital devices to securely authenticate and be authenticated by another party and/or securely handle private information. With the development of the Internet of Things (IOT), it is becoming more common for systems such as heating and lighting to be controlled by internet-connected devices—more and more devices connect to the internet every year.

The inherent difficulties in securely providing secret information to an electronic device, such as an IoT device, can influence further downstream processes, such as enrolment of the device—its initiation into the grid of interconnected devices. Often, secret information such as a pre-shared key or a private key of an asymmetric key pair, and/or a device certificate must be securely provided to the device at the time of manufacture, in order to provide the device with some basic credentials with which to enroll with a service. Once again, there are limitations on how securely this may be done.

In a typical scenario, an Original Equipment Manufacturer (OEM) may seek to furnish a manufactured device with an identity to enable enrolment with an IoT service, and to securely install firmware on the device. The device may include, for example, a microcontroller having a secure region for storing keys, and the microcontroller may have been manufactured by a third party manufacturer. The OEM or the manufacturer may, for example, inject a secret key and a device certificate into the secure region, requiring a secure facility. To install firmware/certificates on the device, the OEM may employ the services of a programming house for configuring the devices, which requires further trust. The programming house must be trusted to operate a secure facility, to inject the correct information, and to securely sign certificates on behalf of the OEM. In some circumstances, provisioning the devices may require multiple different parties to interact with the electronic device. However, these different parties may have access to the information to be installed on the electronic device, for example firmware or certificates, and therefore there is a risk of any of these parties tampering with the information before it is installed on the electronic device.

It is an object of embodiments of the invention to at least mitigate one or more problems known in the art.

### SUMMARY

According to an aspect of the invention a method is provided, the method for providing firmware to an electronic device. The electronic device comprises a security module having a physical unclonable function (PUF), the security module configured to establish a firmware key pair (FPK, FSK) based on a first challenge and response to the PUF, the firmware key pair comprising a firmware public key (FPK) and a firmware secret key (FSK). The method comprises causing a hash of the firmware to be signed using a secret key of an authority key pair to obtain a signature. The authority key pair comprises a public key and the secret key, wherein the public key is embedded securely in the electronic device. The method further comprises encrypting the firmware and the signature using a server encryption key. The method further comprises encrypting a server decryption key using the FPK, the server decryption key for decrypting the encrypted firmware and the encrypted signature. The method further comprises communicating the encrypted firmware, the encrypted signature, and the encrypted server decryption key to a third party for installation on the electronic device.

Advantageously, the method enables firmware to be provided to the electronic device in encrypted form, such that only the electronic device is able to decrypt the firmware. This ensures that the firmware creator, for example an original equipment manufacturer (OEM), can be confident that the proprietary firmware will remain confidential. Other parties involved in the manufacture and programming of the electronic device, for example a third party programming house, are not able to tamper with the firmware without the tampering being detectable.

Advantageously, the firmware key pair is based on a challenge and response to a PUF, which means that no secret information needs to be injected into the device during manufacture, and no secret key need be stored in memory on the device.

The method may further comprise receiving the firmware and performing a hash function on the firmware to generate the hash of the firmware.

The method may further comprise receiving the hash of the firmware.

Causing a hash of the firmware to be signed may comprise signing the hash of the firmware.

Causing a hash of the firmware to be signed may comprise transmitting the hash of the firmware to a trusted authority, and receiving the signature from the trusted authority.

The method may further comprise receiving the FPK from a trusted authority.

The server encryption key may be the same as the server decryption key. Alternatively an asymmetric server encryption key and server decryption key may be used.

The security module may be further configured to establish an enrolment key pair (EPK, ESK) based on a second challenge and response to the PUF, the enrolment key pair comprising an enrolment public key (EPK) and an enrolment secret key (ESK); and the method may further comprise communicating a device identifier to the third party, the device identifier comprising a function of the EPK. Advantageously, the device identifier is accordingly linked to an EPK and ESK that are based on a challenge and response to the PUF and accordingly no secret information need be injected into the device during manufacture to provision the device with an identity.

The device identifier may be received from a trusted authority.

The method may further comprise, after the firmware has been installed on the electronic device, receiving the device identifier and registering the device identifier with the trusted authority. By registering the device identifier with the trusted authority, security is improved as other parties with which the device identifier is not registered may be prohibited from communicating with the electronic device. Specifically, the device identifier becomes associated with a particular server, and so other third parties may not interact with the device without the server's authorisation.

According to an aspect of the invention, a computer readable medium is provided. The computer readable medium has instructions stored thereon which, when executed by one or more processors, cause the one or more processors to perform a method for providing firmware to an electronic device as described herein.

According to an aspect of the invention, computing apparatus is provided. The computing apparatus comprises one or more processors. The computing apparatus further comprises one or more memories having instructions stored thereon which, when executed by the one or more processors, cause the one or more processors to execute a method for providing firmware to an electronic device as described herein.

According to an aspect of the invention, a method is provided for authenticating firmware for an electronic device, the electronic device comprising a security module having a physical unclonable function (PUF), the security module configured to establish a firmware key pair (FPK, FSK) based on a first challenge and response to the PUF and an enrolment key pair (EPK, ESK) based on a second challenge and response to the PUF, wherein the firmware key pair comprises a firmware public key (FPK) and a firmware secret key (FSK), and wherein the enrolment key pair (EPK, ESK) comprises an enrolment public key (EPK) and an enrolment secret key (ESK). The method comprises receiving, from a server, a hash of firmware over a secure communication channel, the firmware for installation on the electronic device. The method comprises signing the hash of the firmware using a secret authority key of an authority key pair comprising a public authority key (PAK) and the secret authority key (SAK), wherein the public authority key is embedded securely in the electronic device. The method comprises initiating communication of the signature to a third party for installation on the electronic device. The method comprises sending, over a secure communication channel to the server, the FPK and an associated device identifier for identifying the electronic device, the device identifier comprising a function of the EPK.

Advantageously, such a method enables an electronic device to receive firmware that has been authorised by a trusted authority, without that trusted authority having access to the firmware. Furthermore, no secret information need be injected into the electronic device in unencrypted form.

The method may further comprise extracting the device identifier from the security module.

The method may further comprise extracting the FPK from the security module.

The method may further comprise receiving the device identifier and the FPK.

The method may further comprise receiving a request to register the device identifier with the server.

The method may further comprise entering the device identifier and the FPK in a lookup table.

According to an aspect of the invention, a computer readable medium is provided. The computer readable medium has instructions thereon which, when executed by one or more processors, cause the one or more processors to perform the method for authenticating firmware for an electronic device as described herein.

According to an aspect of the invention, a computing apparatus is provided. The computer apparatus comprises one or more processors. The computer apparatus further comprises one or more memories having instructions stored thereon which, when executed by the one or more processors, cause the one or more processors to execute a method for authenticating firmware for an electronic device as described herein.

According to an aspect of the invention, a method is provided for performance by an electronic device, the electronic device comprising a security module having a physical unclonable function (PUF), the security module configured to establish a firmware key pair (FPK, FSK) based on a first challenge and response to the PUF, the firmware key pair comprising a firmware public key (FPK) and a firmware secret key (FSK). The method comprises using the FSK, decrypting an encrypted server decryption key, wherein the server decryption key is encrypted using the FPK. The method further comprises using the decrypted server decryption key, decrypting firmware and a signature over a hash of the firmware. The method further comprises verifying, using a public authority key embedded securely in the electronic device, that the hash of the firmware has been signed by a trusted authority. The method further comprises, based on the verifying, installing the decrypted firmware on the electronic device.

The method may further comprise, on booting the electronic device, verifying that the firmware has been signed by a trusted party.

According to an aspect of the invention, an electronic device is provided. The electronic device comprises a security module having a physical unclonable function (PUF), the security module configured to establish a firmware key pair (FPK, FSK) based on a first challenge and response to the PUF, the firmware key pair comprising a firmware public key (FPK) and a firmware secret key (FSK). The electronic device further comprises one or more processors comprising or communicatively coupled to the security module. The one or more processors are configured to use the FSK to decrypt an encrypted server decryption key, wherein the server decryption key is encrypted using the FPK. The one or more processors are configured to use the decrypted server decryption key to decrypt firmware and a signature over a hash of the firmware. The one or more processors are configured to verify, using a public authority key embedded securely in the electronic device, that the hash of the firmware has been signed by a trusted authority. The one or more processors are configured to, based on the verifying, install the decrypted firmware on the electronic device.

Advantageously, the firmware is securely provided to the electronic device. No secret information is stored on the electronic device during manufacture. Furthermore, as part of the security is based on a challenge and response to a PUF installed in the electronic device, the relevant secret key does not ever need to be stored on the electronic device and can instead be dynamically regenerated as required.

According to an aspect of the invention, a system is provided, the system for providing firmware to an electronic device. The electronic device comprises a security module having a physical unclonable function (PUF), the security module configured to establish a firmware key pair (FPK, FSK) based on a first challenge and response to the PUF, wherein the firmware key pair comprises a firmware public key (FPK) and a firmware secret key (FSK). The system comprises a trusted authority and a server. The trusted authority is configured to receive a hash of firmware from the server. The trusted authority is configured to sign the hash of the firmware using a secret authority key of an authority key pair comprising a public authority key and the secret authority key, wherein the public authority key is embedded securely in the electronic device. The trusted authority is configured to send the signature over the hash of the firmware to the server. The trusted authority is configured to send the FPK to the server. The server is configured to receive the signature over the firmware from the trusted authority. The server is configured to receive the FPK from the trusted authority. The server is configured to encrypt the firmware and the signature using a server encryption key. The server is configured to encrypt a server decryption key using the FPK, the server decryption key for decrypting the firmware and the signature. The server is configured to communicate the encrypted firmware, the encrypted signature, and the encrypted server decryption key to a third party for installation on the electronic device.

According to an aspect of the invention, a method is provided, the method for providing firmware to an electronic device. The electronic device comprises a security module having a physical unclonable function (PUF). The security module is configured to establish a firmware key pair (FPK, FSK) based on a first challenge and response to the PUF, the firmware key pair comprising a firmware public key (FPK) and a firmware secret key (FSK). The method comprises causing an encrypted form of the firmware to be signed using a secret key of an authority/signing key pair comprising a public key and the secret key, wherein the public key is embedded securely in the electronic device. The firmware is encrypted using a server encryption key. The method further comprises communicating the signed encrypted form of the firmware to a third party for installation on the electronic device. The method further comprises communicating an encrypted form of a server decryption key to the third party for installation on the electronic device, wherein the server decryption key is for decrypting the encrypted form of the firmware, and wherein the server decryption key is encrypted using the FPK.

Advantageously, the method enables firmware to be provided to the electronic device in encrypted form, such that only the electronic device is able to decrypt the firmware. This ensures that the firmware creator, for example an original equipment manufacturer (OEM), can be confident that the proprietary firmware will remain confidential. Other parties involved in the manufacture and programming of the electronic device are not able to tamper with the firmware.

Advantageously, the firmware key pair is based on a challenge and response to a PUF, which means that no secret information needs to be injected into the device during manufacture, and no secret key need be stored in memory on the device.

The method may further comprise receiving the firmware and encrypting the firmware to generate the encrypted form of the firmware. The method may further comprise receiving the encrypted form of the firmware.

Causing an encrypted form of the firmware to be signed may comprise signing the encrypted form of the firmware. Causing an encrypted form of the firmware to be signed may comprise transmitting the encrypted form of the firmware to a trusted authority, and receiving the signed encrypted form of the firmware from the trusted authority. Signing the encrypted form of the firmware ensures that any tampering of the firmware prior to installation on the device may be detectable, leading to confidence in downstream security measures.

The method may further comprise receiving the FPK from a trusted authority.

The method may further comprise encrypting the server encryption key using the FPK. The server encryption key may be the same as the server decryption key.

The security module may be further configured to establish an enrolment key pair (EPK, ESK) based on a second challenge and response to the PUF, the enrolment key pair comprising an enrolment public key (EPK) and an enrolment secret key (ESK). The method may further comprise communicating a device identifier to the third party, the device identifier comprising a function of the EPK. The function may comprise a cryptographic hash function.

Advantageously, the device identifier is linked to an EPK and ESK that are based on a challenge and response to the PUF and accordingly no secret information need be injected into the device during manufacture.

The device identifier may be received from a trusted authority.

The method may further comprise, after the firmware has been installed on the electronic device, receiving the device identifier and registering the device identifier with the trusted authority. By registering the device identifier with the trusted authority, security is improved as other parties with which the device identifier is not registered may not communicate with the electronic device. Specifically, the device identifier becomes associated with that server, and so other third parties may not interact with the device without the server's authorisation.

According to an aspect of the invention, a computer readable medium is provided. The computer readable medium has instructions stored thereon which, when executed by one or more processors, cause the one or more processors to perform a method for providing firmware to an electronic device as described herein.

According to an aspect of the invention, computing apparatus is provided. The computing apparatus comprises one or more processors. The computing apparatus further comprises one or more memories having instructions stored thereon which, when executed by the one or more processors, cause the one or more processors to execute a method for providing firmware to an electronic device as described herein.

According to an aspect of the invention, a method is provided for authenticating firmware for an electronic device. The electronic device comprises a security module having a physical unclonable function (PUF). The security module is configured to establish a firmware key pair (FPK, FSK) based on a first challenge and response to the PUF and an enrolment key pair (EPK, ESK) based on a second challenge and response to the PUF, wherein the firmware key pair comprises a firmware public key (FPK) and a firmware secret key (FSK), and wherein the enrolment key pair (EPK, ESK) comprises an enrolment public key (EPK) and an enrolment secret key (ESK). The method comprises receiving, from a server, encrypted firmware over a secure communication channel, the firmware for installation on the electronic device. The method further comprises signing the encrypted firmware using a secret authority key of an authority key pair comprising a public authority key and the secret authority key, wherein the public authority key is embedded securely in the electronic device. The method further comprises initiating communication of the signed encrypted firmware to a third party for installation on the electronic device. The method further comprises sending, over a secure communication channel, a lookup table to the server, the lookup table indicating the FPK and an associated device identifier for identifying the electronic device, the device identifier comprising a function of the EPK. The function may comprise a cryptographic hash function.

Advantageously, such a method enables an electronic device to receive firmware that has been authorised by a trusted authority, without that trusted authority having access to the firmware in unencrypted form. Furthermore, no secret information need be injected into the electronic device in unencrypted form.

The method may further comprise extracting the device identifier from the security module. The method may further comprise extracting the FPK from the security module. The method may comprise receiving the device identifier and the FPK.

The method may further comprise receiving a request to register the device identifier with the server. By registering the device identifier with the server, security is improved as other parties with which the device identifier is not registered may not communicate with the electronic device. The method may further comprise entering the device identifier and the FPK in a lookup table.

According to an aspect of the invention, a computer readable medium is provided. The computer readable medium has instructions stored thereon which, when executed by one or more processors, cause the one or more processors to perform a method for authenticating firmware for an electronic device as described herein.

According to an aspect of the invention, computing apparatus is provided. The computing apparatus comprises one or more processors. The computing apparatus further comprises one or more memories having instructions stored thereon which, when executed by the one or more processors, cause the one or more processors to execute a method for authenticating firmware for an electronic device as described herein.

According to an aspect of the invention, a method is provided, the method for performance by an electronic device. The electronic device comprises a security module having a physical unclonable function (PUF). The security module is configured to establish a firmware key pair (FPK, FSK) based on a first challenge and response to the PUF, the firmware key pair comprising a firmware public key (FPK) and a firmware secret key (FSK). The method comprises, using the FSK, decrypting an encrypted server decryption key, wherein the server decryption key is encrypted using the FPK. The method further comprises verifying, using a public authority key embedded securely in the electronic device, that an encrypted form of firmware has been authenticated by a trusted authority. The method further comprises, using the decrypted server decryption key, decrypting firmware for installation on the electronic device.

Advantageously, the firmware is securely provided to the electronic device. No secret information is stored on the electronic device during manufacture. Furthermore, as part of the security is based on a challenge and response to a PUF installed in the electronic device, the relevant secret key does not ever need to be stored on the electronic device and can instead be dynamically regenerated as required.

According to an aspect of the invention, a computer readable medium is provided. The computer readable medium has instructions stored thereon which, when executed by one or more processors, cause the one or more processors to perform a method comprising, using a FSK, decrypting an encrypted server decryption key, wherein the server decryption key is encrypted using a FPK; verifying, using a public authority key embedded securely in the electronic device, that an encrypted form of firmware has been authenticated by a trusted authority; and, using the decrypted server decryption key, decrypting firmware for installation on the electronic device.

According to an aspect of the invention, an electronic device is provided. The electronic device comprises a security module having a physical unclonable function (PUF). The security module is configured to establish a firmware key pair (FPK, FSK) based on a first challenge and response to the PUF, the firmware key pair comprising a firmware public key (FPK) and a firmware secret key (FSK). The electronic device further comprises one or more processors comprising or communicatively coupled to the security module, wherein the one or more processors are configured to: using the FSK, decrypt an encrypted server decryption key, wherein the server decryption key is encrypted using the FPK; verify, using a public authority key embedded securely in the electronic device, that an encrypted form of firmware has been authenticated by a trusted authority; and using the decrypted server decryption key, decrypt firmware for installation on the electronic device.

According to an aspect of the invention a system is provided. The system is for providing firmware to an electronic device. The electronic device comprises a security module having a physical unclonable function (PUF). The security module is configured to establish a firmware key pair (FPK, FSK) based on a first challenge and response to the PUF and an enrolment key pair (EPK, ESK) based on a second challenge and response to the PUF, wherein the firmware key pair comprises a firmware public key (FPK) and a firmware secret key (FSK), and wherein the enrolment key pair (EPK, ESK) comprises an enrolment public key (EPK) and an enrolment secret key (ESK). The system comprises a trusted authority and a server. The trusted authority is configured to receive encrypted firmware from the server. The trusted authority is further configured to sign the encrypted firmware using a secret authority key of an authority key pair comprising a public authority key and the secret authority key, wherein the public authority key is embedded securely in the electronic device. The trusted authority is further configured to send the signed encrypted firmware to the server. The trusted authority is further configured to send a device identifier to the server, the device identifier for identifying the electronic device, the device identifier comprising a function of the EPK. The trusted authority is further configured to send the FPK to the server. The server is configured to send the encrypted form of the firmware to the trusted authority for signing, the firmware encrypted using a server encryption key. The server is further configured to receive the signed encrypted firmware from the trusted authority. The server is further configured to receive the device identifier and the FPK from the trusted authority. The server is further configured to encrypt a server decryption key using the FPK, the server decryption key for decrypting the encrypted firmware. The server is further configured to communicate the device identifier, the encrypted server decryption key, and the signed encrypted firmware to a third party for installation on the electronic device.

A computer program and/or the code/instructions for performing such methods as described herein may be provided to an apparatus, such as a computer, on a computer readable medium or computer program product. The computer readable medium could be, for example, an electronic, magnetic, optical, electromagnetic, infrared, or semiconductor system, or a propagation medium for data transmission, for example for downloading the code over the Internet. Alternatively, the computer readable medium could take the form of a physical computer readable medium such as semiconductor or solid-state memory, magnetic tape, a removable computer diskette, a random access memory (RAM), a read-only memory (ROM), a rigid magnetic disc, and an optical disk, such as a CD-ROM, CD-R/W or DVD.

Many modifications and other embodiments of the inventions set out herein will come to mind to a person skilled in the art to which these inventions pertain in light of the teachings presented herein. Therefore, it will be understood that the disclosure herein is not to be limited to the specific embodiments disclosed herein. Moreover, although the description provided herein provides example embodiments in the context of certain combinations of elements, steps and/or functions may be provided by alternative embodiments without departing from the scope of the invention.

### BRIEF DESCRIPTION OF THE DRAWINGS

Embodiments of the invention are further described, by way of example only, with reference to the accompanying drawings, in which:

FIG. 1 shows a diagram of various parties that are referred to throughout the detailed description for illustrative purposes only;

FIG. 2 shows a communication system;

FIG. 3A shows a block diagram of an electronic device;

FIG. 3B shows a diagram of a microcontroller;

FIG. 4A shows a block diagram of a security module;

FIG. 4B shows a block diagram of a PUF module;

FIG. 5 shows a block diagram of computing apparatus;

FIG. 6A shows a method for providing firmware to an electronic device;

FIG. 6B shows another method for providing firmware to an electronic device;

FIG. 7A shows a flowchart;

FIG. 7B shows a flowchart;

FIG. 8A shows a flowchart;

FIG. 8B shows a flowchart;

FIG. 9A shows a flowchart;

FIG. 9B shows a flowchart; and

FIG. 10 shows a block diagram of a computer readable medium.

Throughout the description and drawings, like reference numerals refer to like parts.

### DETAILED DESCRIPTION

Whilst various embodiments are described below, the invention is not limited to these embodiments, and variations of these embodiments may well fall within the scope of the invention which is to be limited only by the appended claims.

In the following, reference is made to the security and enrolment of an IoT device. However, the skilled person would appreciate that the methods, systems, and apparatuses described herein are far more widely applicable.

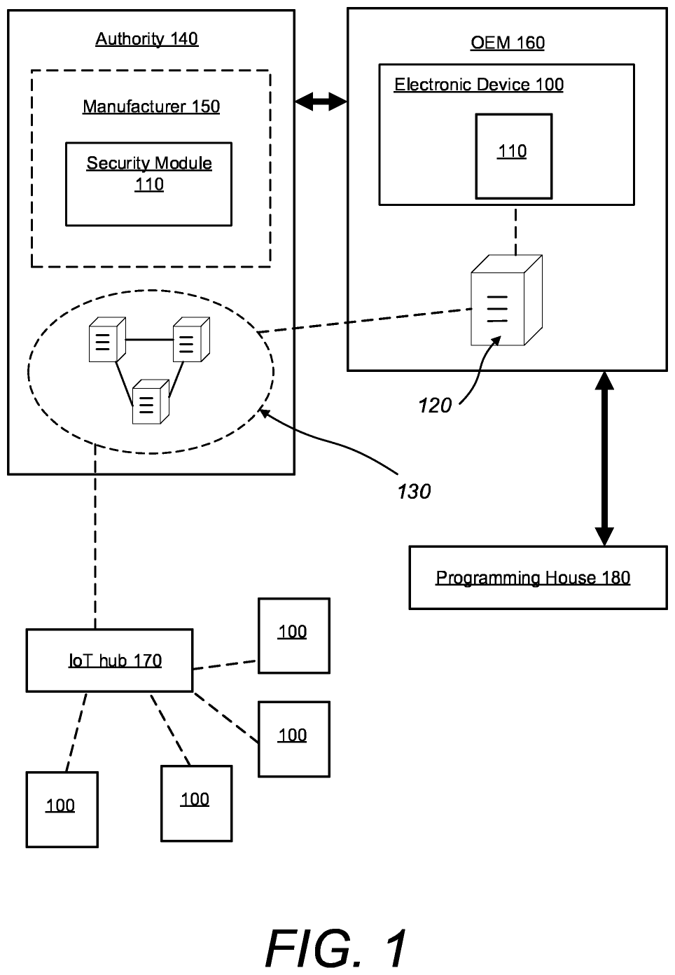

In what follows, methods of securely providing firmware to an electronic device are described. The methods described herein enable firmware to be installed in an electronic device without the need for the various parties involved to particularly trust one another with the security of the electronic device. For ease of explanation, an example scenario of several interested parties (for example an Original Equipment Manufacturer and an IoT hub) is described in FIG. 1 and referenced throughout the detailed description. However, the methods described herein are applicable more generally, as will be appreciated by the skilled person.

As will be appreciated upon reading the detailed description, an electronic device may be provided with a physical unclonable function. Physical unclonable functions (also known as physically unclonable functions, or PUFs) are a cryptographic primitive used for authentication and secret key storage without the requirement of secure EEPROMs and other expensive hardware. Instead of storing secrets in digital memory, PUFs derive a secret from the unique physical characteristics of one or more components, usually introduced during manufacture. Known PUFs are based on phenomena such as the scattering of laser light through a sheet of hardened epoxy in which tiny silica spheres are suspended, or manufacturing variability in gate delay in some circuits.

In what follows, the terms physically unclonable function, physical unclonable function and PUF are used interchangeably. A PUF comprises an object that performs a functional operation, i.e. when queried with a certain input a PUF produces a measurable output. A PUF is not a true function in the mathematical sense, as an input to a PUF may have more than one possible output. Typically, an input to a PUF is referred to as a “challenge” and the resultant output of the PUF is referred to as a “response”. An applied challenge and its measured response is known as a “challenge-response pair” (CRP). The term “challenge” as used herein is understood to mean the selected input provided to the PUF (for example, the selection of particular cells of an array, the application of a particular voltage, and so on) and the term “response” is used herein to refer to the corresponding output of the PUF.

Any suitable PUF may be used with the systems and methods described herein, provided that the PUF is suitable for use in an electronic device. For example, the PUF may be an SRAM PUF. An SRAM PUF uses the random difference in the SRAMs' threshold voltages to create unique challenge-response pairs.

Another example of a suitable PUF is a delay PUF which exploits random variations in delays in wires or gates on a chip. Given an input challenge, a race condition is set up in the circuit and two transitions that propagate along different paths are compared to see which comes first (the response).

In other examples of a PUF, quantum confinement can play a role. For example, a PUF can be formed from several resonant tunnelling diodes.

In other examples of PUFs, quantum tunnelling through a quantum tunnelling barrier may play a role. One example of a PUF has been described in international patent application number PCT/GB2020/050918 filed on 8 Apr. 2020, entitled “Device Identification With Quantum Tunnelling Currents” and published as WO2020/212689A1. According to an example, a PUF may comprise an array having a plurality of individually addressable cells. Each cell may comprise an elementary circuit having a quantum tunnelling barrier. A cell may comprise a first electronic component in the form of a transistor, and a second electronic component in the form of a second electronic transistor. The source, drain, and body of the first transistor may be held at the same potential (e.g. ground). The source, drain, and body of the second transistor may also all be held at that same potential. The first transistor has a first quantum tunnelling barrier between the channel of the transistor and the gate terminal. The second transistor has a second quantum tunnelling barrier between the channel of the transistor and the gate terminal. Due to inherent differences in the transistors introduced during manufacture, the first quantum tunnelling barrier uniquely characterises the first transistor and the second quantum tunnelling barrier uniquely characterises the second transistor. The cell may be selected using a row decoder and column decoder in order to apply a potential difference across the first quantum tunnelling barrier and the second quantum tunnelling barrier. The potential difference may be below a threshold voltage for which current would classically be able to pass through either the first quantum tunnelling barrier or the second quantum tunnelling barrier. Accordingly, once a cell is selected, a quantum tunnelling current may flow through the first quantum tunnelling barrier of the first transistor and a quantum tunnelling current may flow through the second quantum tunnelling barrier of the second transistor, and classical current may not flow. The quantum tunnelling currents may be compared and amplified. The combination of cells and applied voltages may be considered as a challenge and the output quantum tunnelling currents may be considered as a response.

In other examples, a PUF need not be based on electronic components, so long as it can be interacted with electronically.

In what follows, reference is made to several public key pairs, otherwise known as asymmetric key pairs. A public key pair comprises a public key which may be shared with other parties, and a corresponding secret key which is not shared. The public key is a public value that does not need to be kept secret but should be stored so that it cannot be tampered with. In an example, the public key may be stored in ROM in the electronic device to ensure it cannot be rewritten or modified in any way. The public key pairs described herein often have names. For example, one public key pair is described as a “firmware public key pair” comprising a “firmware public key” (FPK) and a corresponding “firmware secret key” (FSK). Another public key pair is described as an “enrolment public key pair” comprising an “enrolment public key” (EPK) and a corresponding “enrolment secret key” (ESK). Another public key pair is described as an “authority key pair” comprising a “public authority key” (PAK) and a corresponding “secret authority key” (SAK). The reader will appreciate that the names of these public key pairs are intended only to differentiate between the public key pairs.

The public key pairs described herein may be used in conjunction with any suitable public key cryptosystem, for example RSA or an elliptic curve based cryptographic system. Many of the public key pairs described herein are for use with digital signatures. A digital signature is a mathematical scheme for verifying the authenticity of digital messages or documents. In the examples herein, any suitable digital signature scheme may be used, for example RSA, ElGamal signature scheme or ECDSA.

Several of the severs/server systems/computing apparatuses described herein have also been given names such as “authority server system” or “key management server”. The reader will appreciate that such names are intended only to differentiate between the different computing apparatuses.

FIG. 1 shows an illustration depicting the commercial (or otherwise) parties that may be engaged in the secure creation, provisioning and deployment of an electronic device 100. The skilled person would appreciate that other set-ups are envisaged and this figure is provided for illustrative purposes only. At a high level, a security module is manufactured and then provided (typically, but not necessarily, as part of a microcontroller) to an original equipment manufacturer (OEM) 160 for installation in an electronic device 100. The OEM 160 then, with the aid of a programming house 180, may take steps to install firmware on the electronic device 100 and ultimately prepare the electronic device 100 for deployment. Once deployed, the electronic device 100 may communicate with a service provided through an IoT hub 170.

Referring to the figure, an authority 140 may have manufacturing capabilities 150 (or may work closely with a trusted manufacturer) to create security modules 110 for installation in an electronic device 100. Examples of security modules and electronic devices are described further below.

For the purposes of the present discussion, a security module 110 includes a physical unclonable function (PUF), not shown in FIG. 1, which is operable to establish public key pairs. A public key pair comprises a public key which may be shared with other parties, and a corresponding secret key which is not shared. A public key pair may also be known as an asymmetric key pair. A public key and a secret key may be based on a challenge and response to the PUF. Accordingly, the security module 110 is able to establish public key pairs without requiring any secret keys to be injected therein by either the manufacturer 150 or any parties downstream.

For the purposes of the present discussion the security module 110 is configured to establish at least two key pairs based on a corresponding at least two challenge-response pairs. Advantageously, with PUF-based public key pairs, the secret keys do not need to be stored on the electronic device but can be dynamically regenerated from the PUF within the secure perimeter/trust zone provided by the security module. Accordingly, even if the electronic device is hacked, there may be no secret key stored there to be stolen.

A firmware public key (FPK) and corresponding firmware secret key (FSK) are based on a first CRP and are used to securely provide firmware to an electronic device as will be described further. The firmware key pair is used to enable the OEM 160 to prepare firmware for the electronic device 100 even if a third party programming house 180 is in some way compromised.

An enrolment public key (EPK) and corresponding enrolment secret key (ESK) are based on a second CRP. The EPK is used to provide an identifier for the electronic device. The device identifier is based on a function of the EPK. While in many of the examples described herein, the function is a cryptographic hash function, this need not be the case and another function may be used. Cryptographic hash functions such as SHA-1 or MD5 are widely used in cryptography. Pseudorandom bit strings are generated by hash functions. A hash function H is a one way function that takes as input an arbitrarily long string of bits m and outputs a bit string of fixed length n. One basic requirement of a hash function is that the hash values H (m) are easy to compute, making both hardware and software implementations practical. A hash function H is a cryptographic hash function if it is collision resistant, that is if it is computationally infeasible to find two non-identical bit strings m and m′ for which H(m)=H(m′). Examples of cryptographic hash functions include MD5, SHA-1, SHA-2, SHA-3, RIPEMD-160, BLAKE2 and BLAKE3.

By securely providing firmware to a device using a PUF to provide an identifier for the electronic device, the electronic device has all of the requirements to build a public key infrastructure and securely connect to an IoT service. Such enrolment processes are described in co-pending GB patent application number 2105185.9, filed 12 Apr. 2021, titled “Interim Root-Of-Trust Enrolment And Device-Bound Public Key Registration”, and in co-pending GB patent application number 2105183.4, filed 12 Apr. 2021, titled “Secure Root-Of-Trust Enrolment And Identity Management Of Embedded Devices”. The content of each of these related applications is hereby incorporated by reference herein in its entirety for all purposes.

For the purposes of the present disclosure, an electronic device 100 may be understood to consist of low level circuitry, such as a microcontroller (MCU). An electronic device 100 may alternatively be understood to comprise higher level circuitry, for example circuitry for sensing humidity or temperature, or may be understood to be a larger scale electronic device such as a smart phone or computer. The manufacturer 150 may manufacture just the security modules 110 or may manufacture a microcontroller having the security module 110 installed therein.

As will be explained further below, the authority 140 may be associated with a public key pair. That is, the authority 140 may be associated with a public key (hereafter referred to as the public authority key, PAK) and a corresponding secret key (hereafter referred to as the secret authority key, SAK). The SAK is not shared with any other party, while the PAK may be shared more widely. For example, the PAK may be imprinted in the security module 110, for example in secure memory. Alternatively, if the manufacturer 150 manufactures microcontrollers (or other electronic devices) comprising the security modules, the PAK may be installed in other read only memory (ROM) of the electronic device, external to the security module. For security purposes it is important that the PAK stored in the security module/electronic device cannot be rewritten or modified in order to preserve its integrity. The PAK may be used by the security module 110 at a later stage to verify that information received has been signed using the SAK and thus has been approved by the authority 140. Other non-secret information may also be imprinted in the security module/electronic device, for example a root certificate signed by the authority 140 using the SAK and indicating that the PAK is associated with the authority 140. No secret information is provided to the security module 110 by the authority 140. No secret information is extracted from the security module 110 by the authority 140 or manufacturer 150.

Initial enrolment firmware (IEF) is also provided to the security module/electronic device for enabling a device identifier and one or more public keys to be extracted from the security module 110.

The authority 140 may own and/or operate a server system 130 comprising one or more servers. While the authority server system 130 of FIG. 1 has been shown with three servers, the skilled person would appreciate that the server system 130 may comprise more or fewer servers.

At least one of the servers of the authority system is configured to sign certificates using the SAK (more information on this is provided further below). The SAK can also be used to sign firmware.

At least one of the servers of the authority server system 130 is configured to hold a database having information on the security modules 110 such as a device identifier.

At least one of the servers of the authority server system 130 is configured to communicate securely with a computing device 120 operated by an original equipment manufacturer (OEM) 160.

At least one of the servers is configured to communicate with an IoT hub 170. An IoT Hub is a managed service, hosted in the cloud, that acts as a message hub for bi-directional communication between an IoT application and the electronic devices it manages. For the purposes of the present discussion, the methods described herein are suitable for provisioning an electronic device so that it may be deployed ready to communicate with an IoT hub 170.

For clarity purposes only, a server of the server system 130 is sometimes referred to herein as an “authority server”.

The skilled person would appreciate that at least some of the functionality of the server system 130 may be provided as a cloud service. One or more of the servers may be located physically external to the authority 140. An authority server of the server system 130 may receive a device identifier for identifying a particular security module 110, the device identifier based on a function of an enrolment public key (EPK) of an enrolment key pair comprising an enrolment secret key (ESK) and the EPK. The server system 130 is configured to store the device identifier in a database. In some examples, the server system 130 may also, but is not required to, receive the EPK for the particular security module 110.

The server system 130 may also, according to some embodiments, receive a firmware public key (FPK) of a firmware key pair comprising a firmware secret key (FSK) and the FPK. The server system 130 may store the device identifier and the corresponding FPK in a database.

Once the server system 130 has received and stored the device identifier of the security module 110, the security module 110 (possibly already installed in a microcontroller) is provided to the OEM 160. The OEM may typically purchase a batch of such security modules for installation in several electronic devices 100 being manufactured by the OEM 160.

The OEM 160 also has access to a computing apparatus 120 capable of securely communicating with the server system 130 of the authority 140. For ease of reference, the computing apparatus 120 operated by the OEM is referred to as a “key management server” in what follows. While the term “key management server” is used in the singular, the skilled person will appreciate that the functionality of the computing apparatus 120 may be shared among a plurality of computing devices and so “key management server” should be understood to also refer to multiple computing devices (a key management server system comprising one or more servers/computing devices) having the desired functionality.

The key management server 120, hereafter referred to as a KMS 120, may be thought of in some situations as another authority server of the authority server system 130, albeit a server with which the OEM 160 is able to interact directly. In particular, the KMS 120 is capable of secure communication with the authority server system 130, and so may be certified for the OEM's use by the authority 140.

The key management server 120 may comprise a physical server provided to the OEM 160 for on-premises operation. For example, the OEM 160 may arrange to obtain a physical KMS 120 from the authority 140. The authority 140 may generate and record a KMS identifier for identifying the particular KMS instance 120 to be provided to the OEM 160. The authority 140 may generate a KMS public key pair in a hardware security module (HSM) inside the KMS 120, extract the KMS public key of the KMS public key pair, and sign a certificate using the SAK to associate the KMS identifier with the KMS public key and the certificate in the KMS software. The authority 140 may also embed in the KMS 120 a root certificate associating the PAK with the authority 140, along with a URL that will enable the KMS to connect with an authority server of the authority server system 130. The KMS 120 may then be physically transferred to the OEM 160. The KMS 120 may subsequently initiate a secure communication (for example, a TLS communication) with the server system 130. The server system 130 may authenticate by presenting a TLS certificate and chain signed by the SAK and performing TLS server authentication. The KMS 120 can then verify the certificate using the hardcoded root certificate associating the PAK with the authority 140. The KMS 120 can authenticate to the authority server by presenting its certificate (signed using the SAK by the authority 140) and performing TLS client authentication. The authority 140 can verify the signature over the certificate using the root public key (PAK) that corresponds to the SAK used to sign the certificate installed in the KMS. The skilled person would appreciate that the public authority key used to certify the KMS 120 may be the same or different to the public authority key installed into the security modules 110.

As opposed to a bespoke physical server provided to the OEM 160 for on-premises operation, the key management server 120 may comprise computing apparatus 120 operated by the OEM 160 but having bespoke software for a secure gateway provided thereon for communicating with the server system 130 of the authority 140. The bespoke software is agnostic for ease of deployment and can be easily installed and operated by OEM 160. The bespoke software includes a mechanism (public key) whereby it can authenticate to the server system 130.

The OEM 160 may use the KMS 120 to register one or more received security modules. Specifically, the KMS 120 may communicate with the security module 110 of an electronic device to extract a device identifier, the device identifier comprising a function of the EPK. The KMS 120 may open a secure communication channel with the authority server system 130 to register with the trusted authority 140 an association between the KMS instance 120 and the device identifier. The authority 140 may update a local database and inform the KMS 120 that is has successfully registered the device identifier, and may grant the KMS 120 certain permissions to communicate with the electronic device associated with that device identifier.

The OEM 160 may use the KMS 120 to securely provide firmware to an electronic device according to a method as described herein. The firmware may include low level instructions for controlling the hardware of the electronic device. The firmware may include one or more root certificates for enrolling the device as per the methods described in co-pending GB patent application number 2105185.9, filed 12 Apr. 2021, titled “Interim Root-Of-Trust Enrolment And Device-Bound Public Key Registration”, and in co-pending GB patent application number 2105183.4, filed 12 Apr. 2021, titled “Secure Root-Of-Trust Enrolment And Identity Management Of Embedded Devices”. The firmware may include an identifier of the KMS 120 with which the device identifier of the electronic device is registered. For example, the identifier may comprise a Uniform Resource Locator (URL) with which the electronic device is to communicate to contact the KMS 120. The firmware may comprise instructions for initiating a secure connection such as a TLS connection with the computing apparatus/server identified by the URL. The firmware may include details of a certificate naming structure, such that the electronic device is able to interpret received certificates. The firmware may further comprise details for establishing a certificate signing request (CSR). A certificate signing request usually contains the public key for which the certificate should be issued, identifying information (such as a device identifier) and integrity protection (e.g., a digital signature).

The key management server 120 is capable of communicating with one more electronic devices 100 also. In this way the one or more electronic devices 100 may be enrolled with the OEM 160. As will be described herein, the KMS 120 may be used to facilitate the secure installation of firmware on an electronic device 100. The KMS 120 may be used to associate device identifiers with specific electronic devices 100. The KMS 120 may be used to sign certificates. Once the firmware is installed on the electronic device, a chain-of-trust can be built up in order to enroll the device with the OEM and ultimately to prepare the device for deployment for secure use with an IoT hub.

The KMS 120 may also be used to securely provide the electronic device with the required information for connecting to an IoT hub 170. For example, the KMS 120 may be configured to communicate with an IoT hub, directly or via the server system 130, to provide device certificates for each enrolled electronic device 100 to the IoT hub. The KMS 120 may be configured to provide an IoT root certificate and an IoT endpoint to the electronic device(s) 100 to enable the device to communicate with the IoT hub 170.

The electronic devices 100 may be deployed with all of the information they require to communicate with the IoT hub 170.

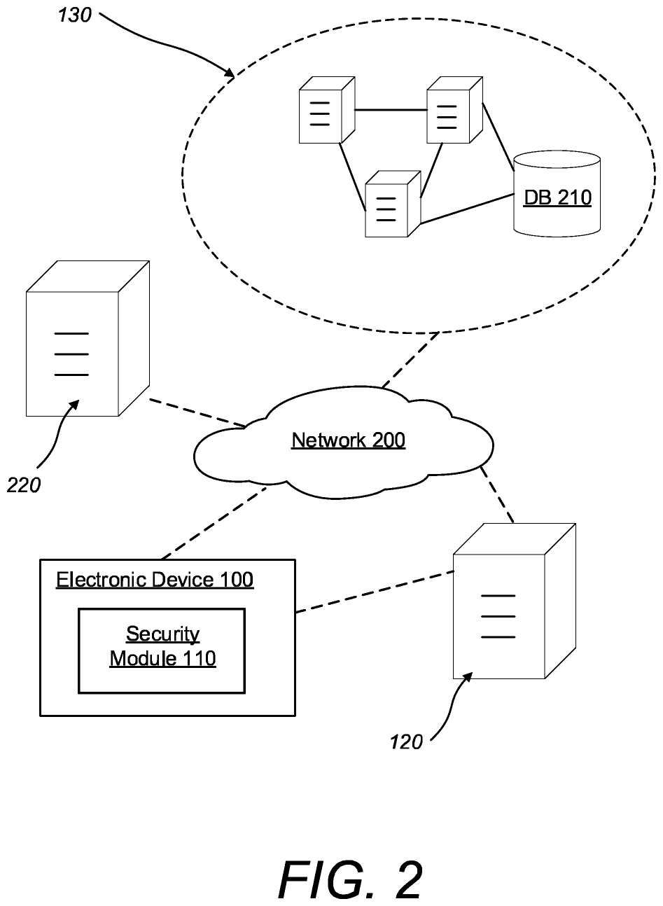

FIG. 2 shows more generally a communication system including many of the hardware devices present in FIG. 1. FIG. 2 in particular shows a communication network 200, an example electronic device 100 having a security module 110, a key management server 120 that may be operated by for example an OEM 160, an authority server system 130, and a computing device 220 that may be operated by, for example, an IoT hub 170. Communication network 200 may be any suitable communication network, such as the Internet. In some examples, the network 200 may comprise a Wide Area Network (WAN).

The electronic device 100 may take any suitable form and may comprise any suitable computing apparatus for performing a method as described herein. For example, the electronic device may be any computing device capable of processing and storage such as a personal computer, a server, a laptop computer, or other such machine. The electronic device 100 may comprise an IoT device. The electronic device may comprise a microcontroller unit (MCU) for installation in a larger device. The electronic device 100 may communicate with other devices directly or via the network 200. For example, the electronic device 100 may communicate with the KMS 120 either via a physical connection or via the network 200. Once the electronic device 100 is deployed, the device 100 may communicate with the computing device 220 over the network 200. The electronic device may communicate with the KMS 120 and/or the computing device 220 over a secure connection, for example a TLS connection.

A KMS 120 may comprise any suitable computing apparatus, such as the computing apparatus 500 discussed further below. A KMS 120 may comprise a cluster of servers or a single device. The functionality of the KMS 120 may be utilized in many different types of data processing environments including a distributed data processing environment, a single data processing device, or the like.

The KMS 120 is able to establish a secure connection with the authority server system 130 via the network 200, and is also able to communicate with the electronic device 100 via the network 200 or, in some circumstances, via a direct connection such as a wired connection. The KMS 120 is configured to store information relating to the electronic device 100, such as the device identifier identifying the security module 110 of the electronic device 100 and one or more public keys, such as the EPK of the electronic device 100. Additionally or alternatively, the KMS 120 may be configured to communicate with the database 210 of the authority server system 130 to obtain such information. The KMS 120 is further configured to sign certificates.

The authority server system 130 comprises one or more servers and includes a database 210. One or more authority servers of the authority server system 130 is configured to sign certificates on behalf of the authority 140, for example to certify that the KMS 120 is trusted by the authority 140 or to sign firmware for installation on the electronic device 100. The database 210 is configured to store information concerning the electronic device 100, such as the device identifier that identifies the electronic device 100, and in some examples the firmware public key FPK of the electronic device 100. The database 210 may be further configured to store information concerning the KMS 120. For example, the database 210 may contain information associating a batch of device identifiers with a particular KMS 120, and may be used to authorise the KMS 120 to interact with only those device identifiers with which it is associated.

The computing device 220 may comprise many connected devices (for example in a distributed computing environment) or a single computing device.

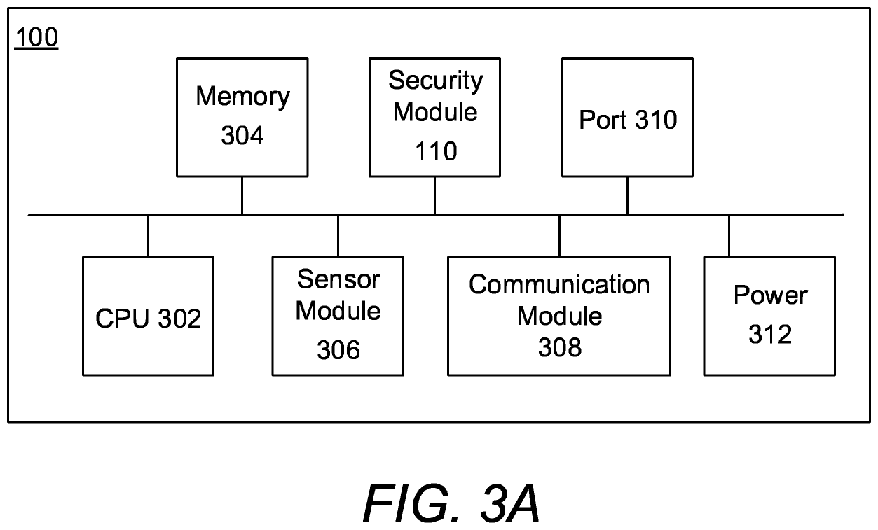

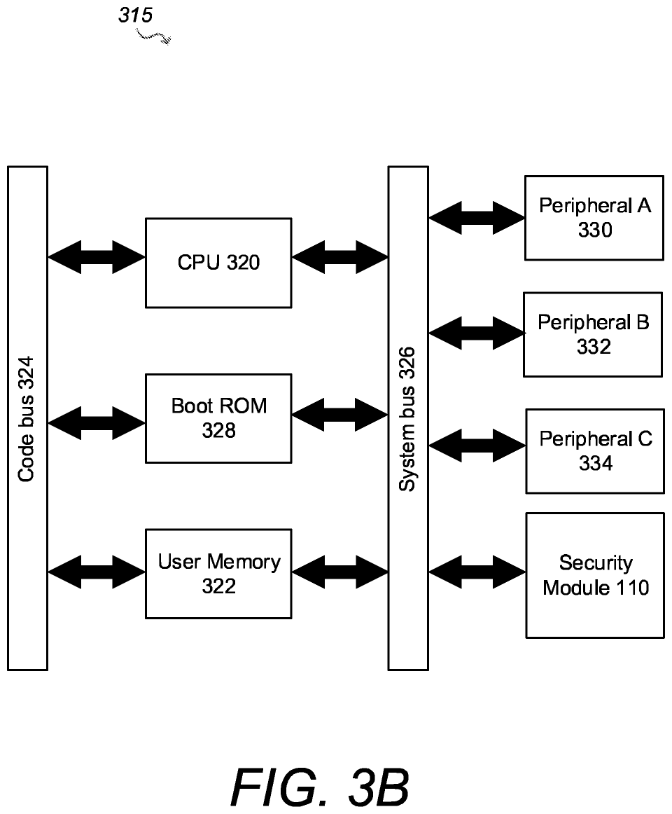

FIG. 3A shows a block diagram of an electronic device 100 according to an example. For example, electronic device 100 may be an IoT device. Other architectures to that shown in FIG. 3A may be used as will be appreciated by the skilled person.

Referring to the figure, electronic device 100 includes a security module 110, one or more CPUs/processors 302, one or more memories 304, a sensor module 306, a communication module 308, a port 310 and a power source 312. Each of components 302, 304, 306, 308, 310, 312 are interconnected using various busses. CPU 302 can process instructions for execution within the electronic device 100, including instructions stored in memory 304, received via communication module 308, or via port 310.

Memory 304 is for storing data within electronic device 100. The one or more memories 304 may include a volatile memory unit or units. The one or more memories may include a non-volatile memory unit or units. The one or more memories 304 may also be another form of computer-readable medium, such as a magnetic or optical disk. One or more memories 304 may provide mass storage for the electronic device 100. Instructions for performing a method as described herein may be stored within the one or more memories 304.

The communications module 308 is suitable for sending and receiving communications between processor 302 and other systems. For example, communication module 308 may be used to send and receive communications via a communication network 200 such as the Internet. Communication module 308 may enable the electronic device 100 to communicate with other devices/servers by any of a number of protocols, such as WiFi®, Bluetooth®, NFC, etc.

The port 310 is suitable for receiving, for example, a non-transitory computer readable medium containing instruction to be processed by the processor 302. The port 310 may be used, for example, for wired communications between the electronic device 100 and the key management server 120.

The sensor module 306 may comprise one or more sensors for a sensing parameter such as temperature, humidity, or any other parameter.

The processor 302 is configured to receive data, for example from the sensor module 306, the security module 110, or the communication module 308. The processor 302 is further configured to access the memory 304, and to act upon instructions and/or information received either from said memory 304, from communication module 308, or a computer-readable storage medium connected to port 310.

FIG. 3B shows architecture for another example of an electronic device 100, namely a microcontroller unit (MCU) 315, which may be installed within a larger electronic device. The skilled person would appreciate that other MCU architectures may be used.

The MCU 315 of FIG. 3B comprises a CPU 320, a user memory 322 and a Boot Random Access Memory 328. The CPU 320, Boot ROM 328 and user memory 322 may communicate via a code bus 324. The CPU 320, Boot ROM 328, and user memory 322 may be connected to a system bus 326, which may also be connected to a plurality of peripherals A, B and C (330, 332, and 334) and a security module 110. Only the components relevant to security have been illustrated in the MCU 315. The skilled person would appreciate that the MCU 315 may have more or fewer components. For example, the MCU 315 may have more peripherals and system components.

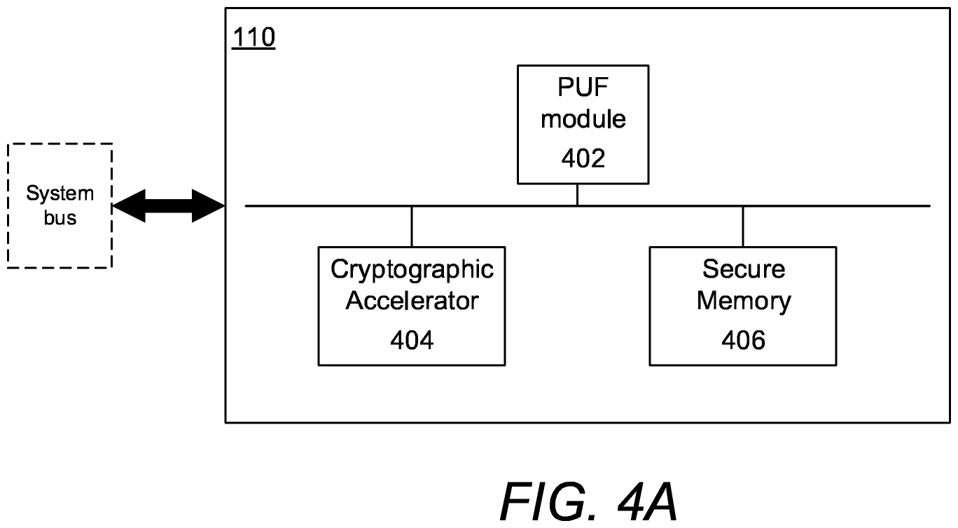

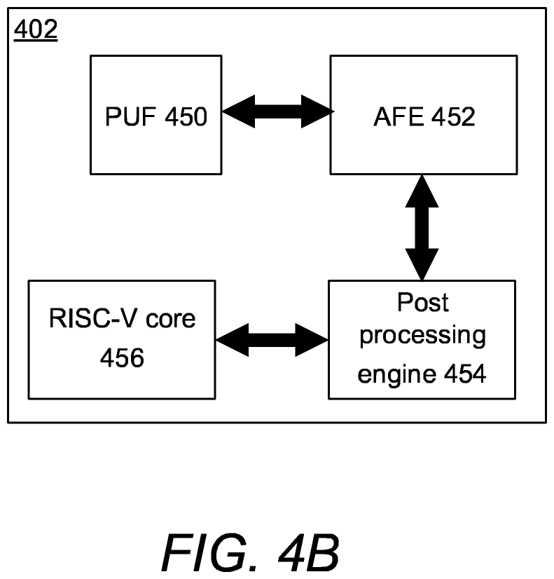

FIG. 4A shows a block diagram of a security module 110 according to an example. The security module 110 may be considered as a trust zone separating the secure components within from the other components of the electronic device 100. The security module 110 comprises a PUF module 402, a cryptographic accelerator 404 and a secure memory 406. The skilled person would appreciate that other architectures are also possible. The security module 110 is connected to a system bus of the electronic device 100.

The PUF module 410 comprises a PUF and any circuitry required to interact with the PUF. In particular, the PUF module may receive signals from the cryptographic accelerator 404 and provide an appropriate response. The cryptographic accelerator 404 comprises a dedicated processing unit for performing cryptographic operations and for interacting with the PUF module 402 and the secure memory 406.

The secure memory is configured to store secret information such as keys produced by the PUF module 402 and/or root certificates. The instructions needed by the CPU 320 to control the PUF module 402, security peripherals within the Security Module 110 and the secure memory are contained within the Boot ROM 328 which is part of the immutable booting process for the system.

FIG. 4B illustrates the functional components of a PUF module 402 according to an example. The PUF module 402 comprises a PUF 450, an analog front-end (AFE) 452, a post-processing engine 454, and a RISC-V core 456.

The skilled person will appreciate that the PUF 450 may be any suitable PUF.

The analog front end (AFE) 452 comprises analog signal conditioning circuitry for interacting with the PUF. For example, the AFE may interact with the PUF 450 to establish a raw “fingerprint”. The post-processing engine 454 is configured to correct the output of the AFE 452 and to provide further privacy enhancement by further processing the output of the AFE. The RISC-V core 456 is a CPU core that performs post processing of the data from the PUF 450, for example, error correction of the data. A RISC-V core provides an interface that allows easy connection of the PUF module 402 to an external microcontroller, although other CPU cores may be utilised.

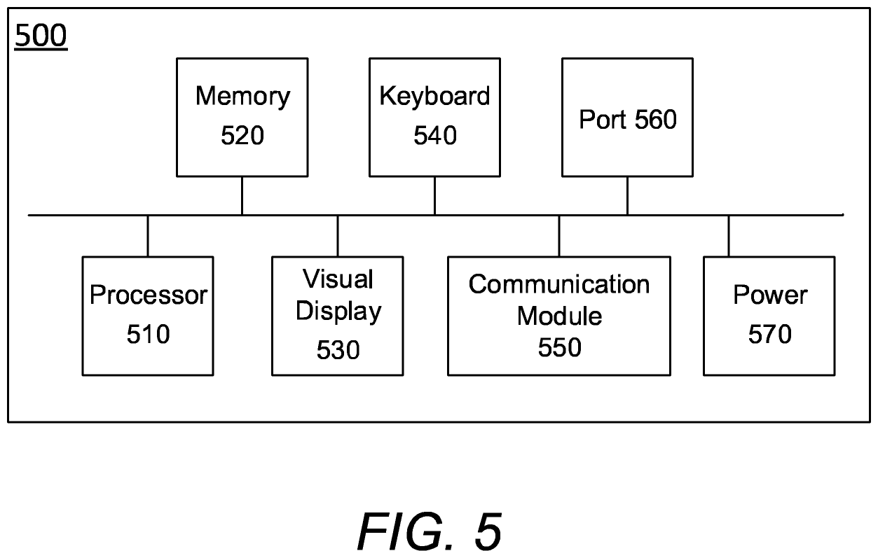

FIG. 5 is a block diagram of a computing apparatus 500. For example, computing apparatus 500 may comprise a computing device, a server, a mobile or portable computer or telephone and so on. Computing apparatus 500 may be distributed across multiple connected devices. Computing apparatus 500 may be suitable for use as a key management server 120, an authority server of an authority server system 130, or a server 220 for use in for example an IoT hub. Other architectures to that shown in FIG. 5 may be used as will be appreciated by the skilled person.

Referring to the figure, computing apparatus 500 includes one or more processors 510, one or more memories 520, a number of optional user interfaces such as visual display 530 and virtual or physical keyboard 540, a communication module 550, and optionally a port 560 and optionally a power source 570. Each of components 510, 520, 530, 540, 550, 560, and 570 are interconnected using various busses. Processor 510 can process instructions for execution within the computing apparatus 500, including instructions stored in memory 520, received via communication module 550, or via port 560.

Memory 520 is for storing data within computing apparatus 500. The one or more memories 520 may include a volatile memory unit or units. The one or more memories may include a non-volatile memory unit or units. The one or more memories 520 may also be another form of computer-readable medium, such as a magnetic or optical disk. One or more memories 520 may provide mass storage for the computing apparatus 500. Instructions for performing a method as described herein may be stored within the one or more memories 520.

The apparatus 500 includes a number of user interfaces including visualising means such as a visual display 530 and a virtual or dedicated user input device such as keyboard 540.

The communications module 550 is suitable for sending and receiving communications between processor 510 and remote systems. For example, communications module 550 may be used to send and receive communications via a communication network 200 such as the Internet.

The port 560 is suitable for receiving, for example, a non-transitory computer readable medium containing instruction to be processed by the processor 510.

The processor 510 is configured to receive data, access the memory 520, and to act upon instructions received either from said memory 520 or a computer-readable storage medium connected to port 560, from communications module 550 or from user input device 540.

The computing apparatus 500 may further comprise a hardware security module (HSM), not shown in FIG. 5, in order to store cryptographic keys securely. For example, for computing apparatus 500 used as a key management server 120, a HSM may be required to store one or more secret keys for signing certificates, or a server encryption key and server decryption key for encrypting/decrypting firmware. For example, for computing apparatus 500 used as an authority server of an authority server system 130, a HSM may be required to store one or more secret keys such as a secret authority key (SAK) of an authority key pair. The skilled person would appreciate that an HSM is not required to store secret keys and other security arrangements may be applicable. For example a computing apparatus may access a cloud-based HSM.

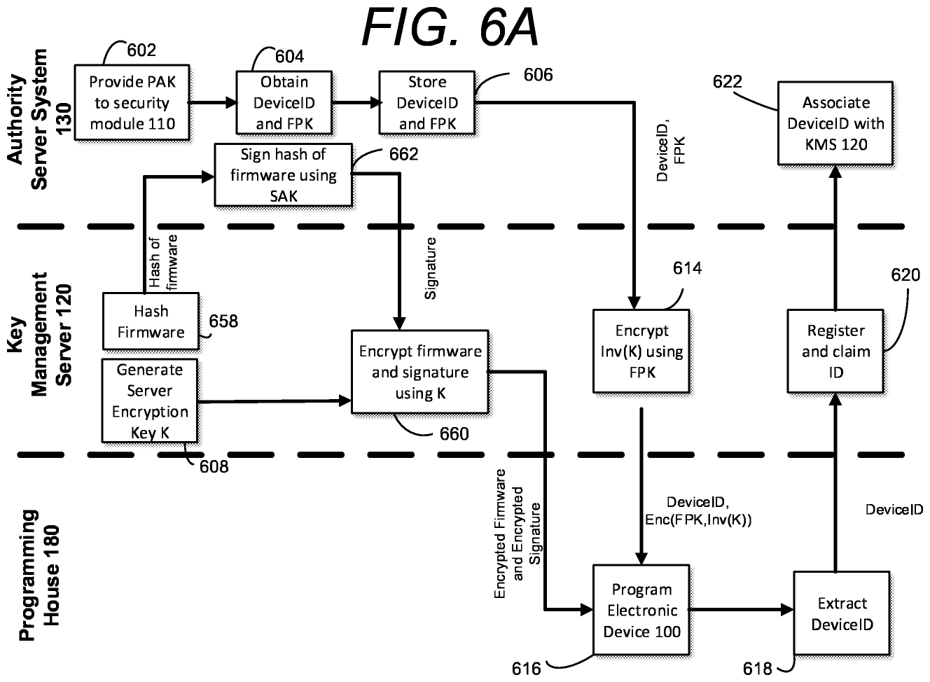

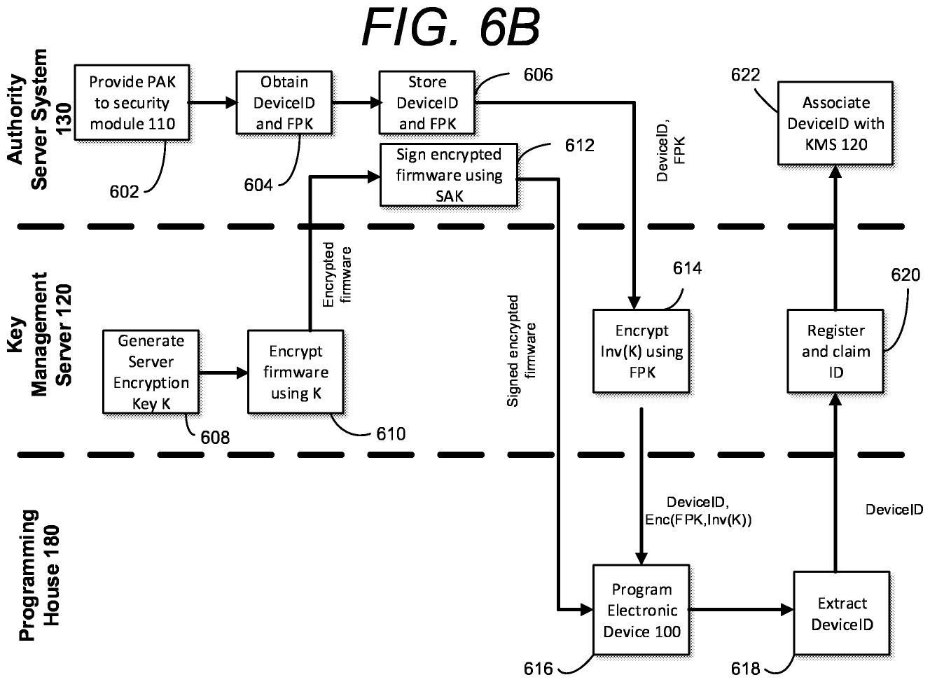

FIG. 6A shows a method for providing firmware securely onto an electronic device 100 according to an example. In this example, and with reference to FIG. 1, an OEM 160 is seeking to install firmware on an electronic device 100 and for this purpose employs a third party programming house 180. The OEM 160 has access to a key management server 120 capable of secure communication with an authority server system 130.

The authority 140/manufacturer 150 is configured to produce a security module 110 (and optionally install it within an MCU 315).

The security module 110 comprises a PUF 450. The security module 110 is configured to generate a firmware key pair (FPK, FSK) based on a first challenge and response to the PUF, the firmware key pair comprising a firmware public key (FPK) and a firmware secret key (FSK). The security module 110 is further configured to generate an enrolment key pair (EPK, ESK) based on a second challenge and response to the PUF, the enrolment key pair comprising an enrolment public key (EPK) and an enrolment secret key (ESK). The secret keys FSK and ESK do not leave the security module 110. Indeed, as these secret keys are based on responses from the PUF 450, they do not need to be stored in memory and can be dynamically regenerated from the PUF 450 with the appropriate input.

The security module 110 is configured to generate a device identifier (“DeviceID” in FIG. 6A) which will be used to identify the electronic device 100 in which the security module 110 is ultimately installed. The device identifier is determined based on a function of the enrolment public key EPK, and preferably a non-linear function. By basing the device identifier on a function of the EPK, the identity of the security module 110 is based on a physical property of the security module 110 and therefore cannot be spoofed.

According to an example, the device identifier may be determined by applying a cryptographic hash function to the EPK.

According to the example in FIG. 6A, the device identifier is generated by applying a cryptographic hash function to the enrolment public key.

Referring to FIG. 6A, at step 602 a public authority key PAK is provided to the security module during manufacture. For example, the PAK may be stored in secure memory 406 of the security module 110. In an example, the secure memory 406 may be read only memory (ROM). The ROM cannot be rewritten or modified in any way and therefore storing the PAK in ROM ensures it cannot be tampered with. The public authority key PAK is a public key of an authority key pair comprising a secret authority key SAK and the PAK. While the secret authority key SAK is known only to the authority 140 (or a server of the authority server system 130), the PAK may be shared widely. The skilled person would appreciate that while in FIG. 6A the PAK is provided to the security module 110 by the server system 130, the PAK may be provided to the security module by some other entity, for example, the PAK may be embedded in the security module by a trusted manufacturer 150. The security module 110 may also be provided with initial enrolment firmware comprising basic software for performing the required security functionality, such as enabling a device identifier and one or more public keys to be extracted, and such as initiating a secure connection with an endpoint (e.g. a URL) stored locally. Moreover, the skilled person would appreciate that, while the public authority key PAK is provided to the security module 110 in step 602 of FIG. 6A, the PAK may be provided to other parts of the electronic device 100 and embedded securely in the electronic device 100.

At 604, the authority server system 130 obtains the device identifier and the firmware public key FPK for the security module 110. The device identifier comprises a hash of the enrolment public key EPK. The server system 130 may extract the device identifier and FPK from the device or may receive them from, for example, the manufacturer 150.

The security module 110 may be one security module of a batch of security modules. The server system 130 may accordingly obtain many device identifiers and corresponding FPKs. At 606, the server system 130 stores the device ID and corresponding FPK in a database 210 for later reference.

Once the device identifiers and corresponding FPKs have been obtained and stored by the server system 130, the security module 110 (or MCU 315 containing the security module) may be transported to an OEM 160 for installation in an electronic device 100.

In the scenario described with reference to FIG. 6A, the OEM 160 designs firmware for installation on the electronic device 100. The firmware may further comprise one or more root certificates self-signed by the OEM to enable a chain-of-trust to be built during enrolment of the electronic device. The firmware may comprise low level instructions for controlling the hardware of the electronic device 100. The firmware is provided to the key management server 120 which, at step 608, generates a server encryption key K for encrypting the firmware. The server encryption key K may be a key for a symmetric cryptographic function, or may be a key for an asymmetric cryptographic function. That is, the server decryption key (“Inv(K)” in FIG. 6A) may be the same as the server encryption key K or may be different. At 658, the KMS 120 applies a cryptographic hash function to the firmware. This may occur before, during or after the server encryption key is generated 608.

The KMS 120 is capable of secure communication with the authority server system 130 and the hash of firmware is sent to the server system 130. By sending the hash of the firmware from the KMS 120 to the server system 130, the firmware itself need not transmitted and the server system 130 itself is unable to modify the firmware. At 662, the authority server system 130 signs the hash of the firmware using the secret authority key SAK. Accordingly, any entity that would use the public authority key PAK with the signature over the hash of the firmware would be able to verify that the hash of the firmware has been signed by the server system 130.

The signature over the hash of the firmware is then sent back to the KMS 120. At 660, the KMS 120 encrypts the firmware and the signature using server encryption key K.

The server encryption key used to encrypt the firmware may be the same for different firmwares, or may be different. For example, the OEM 160 may produce first firmware for a first batch of electronic devices and may produce second firmware for a second batch of electronic devices, and may use the same server encryption key K to encrypt both the first firmware and the second firmware, or may use firmware-specific encryption keys. Furthermore, in some examples, for each batch of electronic devices 100 that the OEM produces, there may be a different server encryption key.

The authority server system 130 also securely communicates the device identifier (“DeviceID”) and corresponding FPK to the key management server 120. The device identifiers and FPKs of multiple security modules 110 may be communicated individually or in bulk, for example in the form of a look-up table, to the KMS 120.

At 614, the KMS encrypts the server decryption key Inv(K) using the FPK. The encrypted server decryption key (labelled “Enc(FPK,Inv(K))” in FIG. 6A) and corresponding device identifier is communicated to the programming house 180. For example, a look-up table comprising multiple device identifiers and corresponding encrypted server decryption keys may be provided to the programming house 180. The server decryption key is for decrypting the firmware and the signed hash.

The encrypted firmware, encrypted signature and encrypted server decryption key are then sent to the programming house 180 for installation on the electronic device 100.

At 616, for a given electronic device 100, the programming house 180 installs the corresponding encrypted server decryption key onto the electronic device 100. The programming house further provides the encrypted firmware to the electronic device 100 for installation.

The electronic device 100 containing the security module 110 contains all of the information required to decrypt and install the firmware. As the encrypted server decryption key Enc(FPK,Inv(K)) was encrypted using the FPK, the electronic device 100 is able to decrypt the server decryption key using the FSK. As the signature over the hash of the firmware was signed using the SAK, the electronic device is able to verify the signature using the PAK. The electronic device is further able to decrypt the encrypted firmware using the server decryption key Inv(K). The electronic device 100 is further able to check that the signature corresponds to the received firmware by, for example, applying a hash function to the decrypted firmware and comparing to that signed by the authority server system 130. Based on the verifying, the electronic device 100 can install the decrypted firmware on the electronic device 100.

Optionally, on booting the electronic device may verify the firmware by hashing the firmware and checking the hash using the signature. In this way, the firmware may be verified each time the electronic device boots.

Accordingly, the methodology of FIG. 6A ensures that no secret information need be injected into the electronic device 100 (or security module 110 prior to installation in the electronic device 100) in unencrypted form at any stage. The OEM 160 can be sure that the firmware provided to an electronic device 100 can be modified prior to installation on the electronic device 100 without detection, which reduces the need to wholly trust e.g. a third party programming house 180. The authority server system 130 also does not see, nor has the opportunity to modify, the firmware as it only receives a hash of the firmware.

Optionally, the programming house 180 may extract the device identifier (at 618) from the electronic device 100 and communicate this to the KMS 120 which may undertake steps to register the device identifier with the authority server system (at 620). The authority server system 130 may then associate the device identifier with the KMS by, for example, storing this information in a database 210. In other examples, the devices identifiers can be registered by the KMS 120 after receiving them from the server system 130 (arrow between 606 and 614). The registration of the device identifiers need not be linked in any way to the method of providing firmware to the electronic device. For example, the OEM 160 may be provided with a file of device identifiers by the manufacturer 150 from which they received the security modules 110/microcontrollers 315, and may manually upload the device identifiers to the KMS 120 for registration.

Registering the device identifiers with the authority server system 130 ensures that the KMS 120 is associated with the claimed device identifiers, and acts as a further security check. The authority server system 130 may be in communication with many key management servers, and so linking the device identifier with the KMS 120 ensures that the correct OEM 160 is provisioning and deploying a device having a particular security module 110.

The process for registering and claiming the device identifiers may work as follows. The KMS 120, having knowledge of the device identifiers, may establish a secure connection, for example a TLS connection, with an authority server of the authority server system 130. The KMS 120 may then send one or more device identifiers to the authority server over the TLS connection. The server system 130 may validate the one or more device identifiers using the information stored in the database 210. In particular, the server system 130 may check that all of the device identifiers correspond to real devices (i.e. that they have a corresponding entry in the database 210), and that none of the received device identifiers have been previously claimed by a second KMS. If the checks succeed, the server system 130 may update the database 210 to indicate that the KMS 120 that claimed the device identifiers is associated with the device identifiers—that is, that the KMS 120 “owns” those device identifiers. Once this registration is complete, a success indication may be sent back to the KMS 120. The success indication may, for example, enable the KMS 120 to establish a secure TLS connection with the electronic device, and/or may cause the device identifiers (or a further icon) to appear in a user interface on the KMS 120. The secure connection between the KMS 120 and authority server system 130 may then be closed.

FIG. 6B shows another method for providing firmware securely onto an electronic device 100 according to an example. In this example, and with reference to FIG. 1, an OEM 160 is seeking to install firmware on an electronic device 100 and for this purpose employs a third party programming house 180. The OEM 160 has access to a key management server 120 capable of secure communication with an authority server system 130.

The security module 110 is configured to generate a device identifier (“DeviceID” in FIG. 6B) which will be used to identify the electronic device 100 in which the security module 110 is ultimately installed. The device identifier is determined based on a function of the enrolment public key EPK, and preferably a non-linear function. By basing the device identifier on a function of the EPK, the identity of the security module 110 is based on a physical property of the security module 110 and therefore cannot be spoofed.

As in FIG. 6A, at step 602 a public authority key PAK is provided to the security module (or other secure memory of a microcontroller) during manufacture.

At 604, the server system 130 obtains the device identifier and the firmware public key FPK for the security module 110. The device identifier comprises a hash of the enrolment public key EPK. The server system 130 may extract the device identifier and FPK from the device or may receive them from, for example, the manufacturer 150.

The security module 110 may be one security module of a batch of security modules. The server system 130 may accordingly obtain many device identifiers and corresponding FPKs. At 606, the server system 130 stores the device ID and corresponding FPK in a database 210 for later reference.

Once the device identifiers and corresponding FPKs have been obtained and stored by the server system 130, the security module 110 (or MCU 315 containing the security module) may be transported to an OEM 160 for installation in an electronic device 100.

As with the scenario described in FIG. 6A, in the scenario of FIG. 6B, the OEM 160 designs firmware for installation on the electronic device 100. The firmware is provided to the key management server 120 which, at step 608, generates a server encryption key K for encrypting the firmware. At 610, the KMS 120 encrypts the firmware using server encryption key K.

The KMS 120 is capable of secure communication with the server system 130 and the encrypted firmware is sent to the server system 130, which at 612 signs the encrypted firmware using the secret authority key SAK. Accordingly, any entity that would use the public authority key PAK with the signed encrypted firmware would be able to verify that the encrypted firmware has been signed by the server system 130. The signed, encrypted firmware is sent, optionally via the KMS 120, to the programming house 180.

The authority server system 130 also securely communicates the device identifier (“DeviceID”) and corresponding FPK to the key management server 120. The device identifiers and FPKs of multiple security modules 110 may be communicated individually or in bulk, for example in the form of a look-up table, to the KMS 120.

At 614, the KMS encrypts the server decryption key Inv(K) using the FPK. The encrypted server decryption key (labelled “Enc(FPK,Inv(K))” in FIG. 6B) and corresponding device identifier is communicated to the programming house 180. For example, a look-up table comprising multiple device identifiers and corresponding encrypted server decryption keys may be provided to the programming house 180.

At 616, for a given electronic device 100, the programming house 180 provides the corresponding encrypted server decryption key to the electronic device 100. The programming house further provides the signed encrypted firmware to the electronic device 100.

The electronic device 100 containing the security module 110 contains all of the information required to decrypt and install the firmware. As the encrypted server decryption key Enc(FPK,Inv(K)) was encrypted using the FPK, the electronic device 100 is able to decrypt the server decryption key using the FSK. As the signed encrypted firmware was signed using the SAK, the electronic device is able to verify the signed encrypted firmware using the PAK. The electronic device 100 is further able to decrypt the firmware using the server decryption key Inv(K).

Optionally, the programming house 180 may extract the device identifier (at 618) from the electronic device 100 and communicate this to the KMS 120 which may undertake steps to register the device identifier with the authority server system (at 620). The authority server system 130 may then associate the device identifier with the KMS by, for example, storing this information in a database 210. In other examples, the devices identifiers can be registered by the KMS 120 after receiving them from the server system 130 (arrow between 606 and 614). The registration of the device identifiers need not be linked in any way to the method of providing firmware to the electronic device. For example, the OEM 160 may be provided with a file of device identifiers by the manufacturer 150 from which they received the security modules 110/microcontrollers 315, and may manually upload the device identifiers to the KMS 120 for registration.

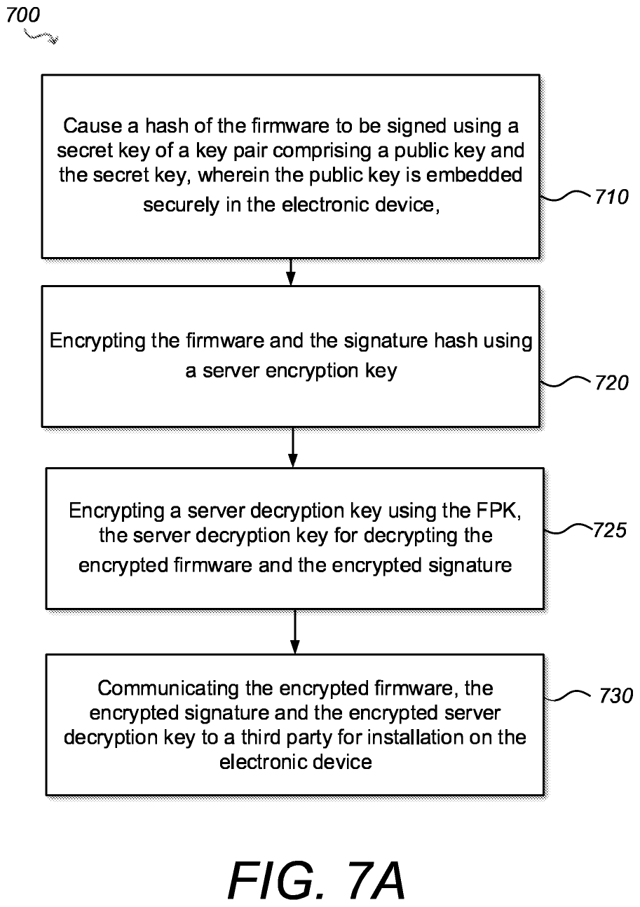

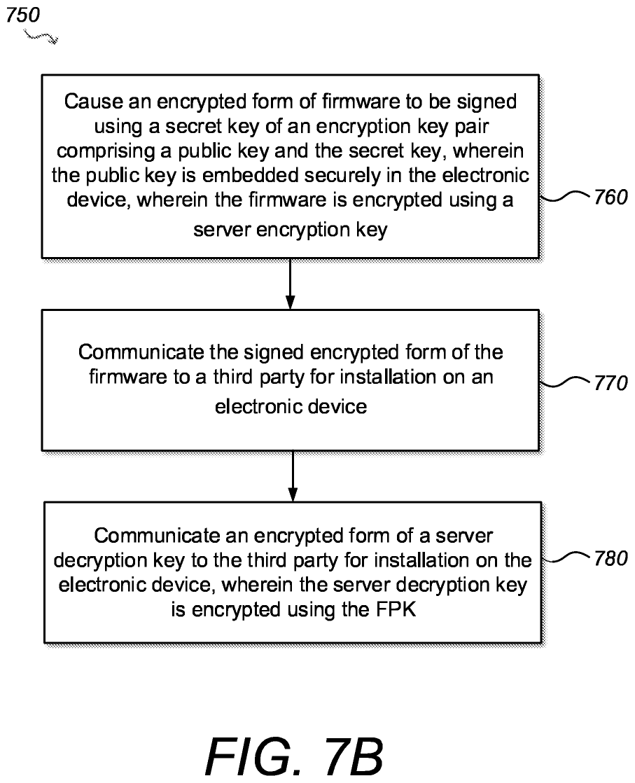

FIG. 7A shows a flowchart of a general method 700 for providing firmware to an electronic device 100. It is assumed that the electronic device 100 comprises a security module 110 having a PUF 450. The security module 110 is configured to establish a firmware key pair (FPK, FSK) based on a first challenge and response to the PUF, the firmware key pair comprising a firmware public key (FPK) and a firmware secret key (FSK). It is further assumed that a public key is embedded securely in the electronic device 100, for example, in the security module 110 of the electronic device 100. The public key is a part of a public key pair comprising the public key and a corresponding secret key. The signing key pair may be an authority key pair comprising a public authority key and a secret authority key known only to an authority 140. The method 700 may be performed by, for example, a key management server 120.

At 710, the method 700 comprises causing a hash of the firmware to be signed using a secret key of a signing key pair comprising a public key and the secret key, wherein the public key is embedded securely in the electronic device.

In some embodiments, the key management server 120 may be configured to sign the hash of the firmware with the secret key of the signing key pair. However, in other embodiments (such as that shown in FIG. 6A), the key management server 120 may be configured to establish a secure connection with an authority server of an authority server system 130. The KMS 120 may then communicate the hash of the firmware to the authority server, and receive a signature over the signed hash of the firmware, wherein the hash of the firmware is signed using the secret key of the signing key pair. That is, the signing key pair may comprise a public authority key PAK and a secret authority key SAK, and the server system 130 may sign the hash of the firmware with the SAK.

At 720, the method 700 comprises encrypting the firmware and the signature using a server encryption key 100. The server encryption key may be based at least in part on user credentials, for example a password of the user (e.g. a password of the OEM).

At 725, the method 700 comprises encrypting a server decryption key using the FPK. The server decryption key is for decrypting the encrypted firmware and the encrypted signature.

At 730, the method 700 comprises communicating the encrypted firmware, the encrypted signature, and the encrypted server decryption key to a third party for installation on the electronic device. The third party may comprise, for example, a server of a programming house 180 or any other computing device outside of the KMS and authority server system 130.

The FPK may be received over a secure connection from the authority server 130 (as in FIG. 6A), or may be received in some other way. For example, the FPK may be uploaded directly to the KMS 120 or may be received from some other information source.

FIG. 7B shows a flowchart of a general method 750 for providing firmware to an electronic device 100. It is assumed that the electronic device 100 comprises a security module 110 having a PUF 450. The security module 110 is configured to establish a firmware key pair (FPK, FSK) based on a first challenge and response to the PUF. It is further assumed that a public key is embedded securely in the electronic device 100, for example, in the security module 110 of the electronic device 100. The public key is a part of a signing key pair comprising the public key and a corresponding secret key. The signing key pair may be an authority key pair comprising a public authority key and a secret authority key known only to an authority 140. The method 750 may be performed by, for example, a key management server 120.

At 760, the method 750 comprises causing an encrypted form of the firmware to be signed using the secret key of the signing key pair. The firmware is encrypted using a server encryption key K. The server encryption key may be based at least in part on user credentials, for example a password of the user (e.g. a password of the OEM).

For example, a key management server 120 may have received the firmware in unencrypted form and then encrypt the firmware using a server encryption key K (as in FIG. 6B), or may directly receive the encrypted form of the firmware. In some embodiments, the key management server 120 may be configured to sign the encrypted form of the firmware with the secret key of the signing key pair. However, in other embodiments (such as that shown in FIG. 6B), the key management server 120 may be configured to establish a secure connection with an authority server of an authority server system 130. The KMS 120 may then communicate the encrypted form of the firmware to the authority server, and receive a signed encrypted form of the firmware, wherein the signed encrypted form of the firmware is signed using the secret authority key of the authority key pair.

At 770, the method 750 comprises communicating the signed encrypted form of the firmware to a third party for installation on the electronic device 100. The third party may comprise, for example, a server of a programming house 180 or any other computing device outside of the KMS and authority server system 130.

At 780, the method 750 comprises communicating an encrypted form of a server decryption key to the third party for installation on the electronic device, wherein the server decryption key is encrypted using the FPK. Of course, the encrypted form of the server decryption key may be communicated to the third party before, at the same time as, or after the signed encrypted form of firmware communicated to the third party.

The FPK may be received over a secure connection from the authority server 130 (as in FIG. 6A), or may be received in some other way. For example, the FPK may be uploaded directly to the KMS 120 or may be received from some other information source.

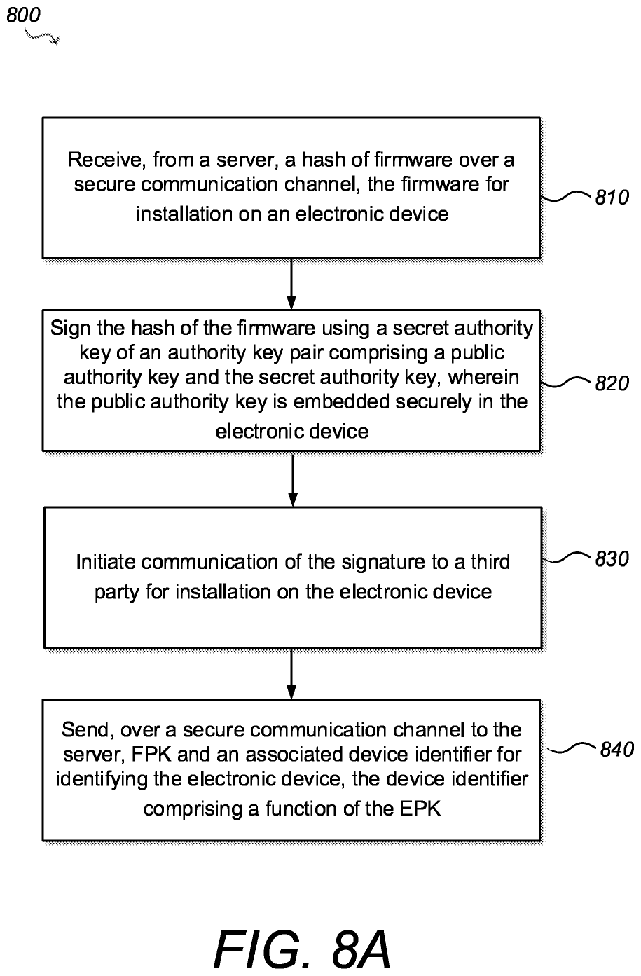

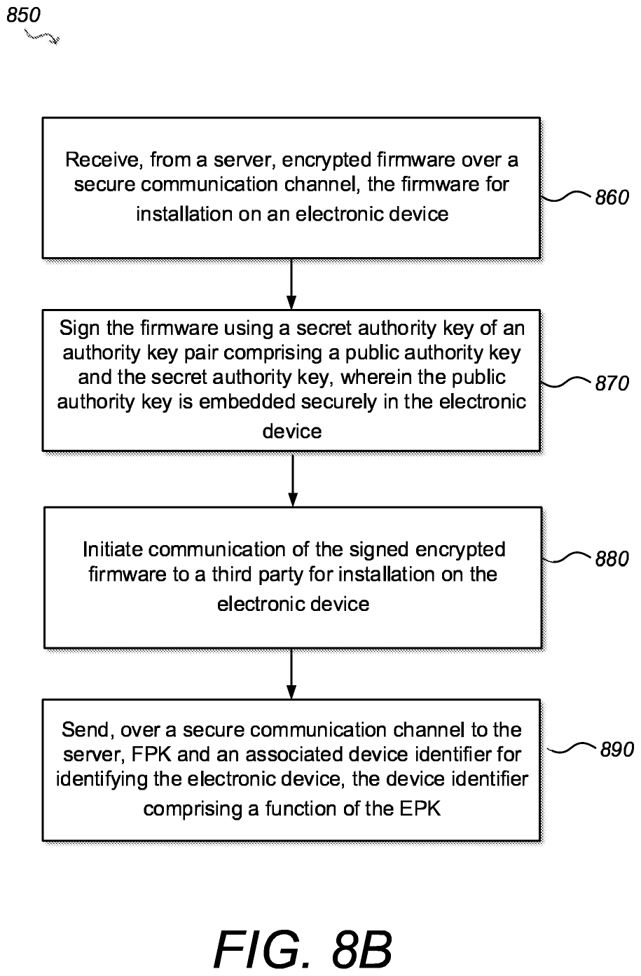

FIG. 8A shows a flowchart of a general method 800 for authenticating firmware for an electronic device 100. It is assumed that the electronic device 100 comprises a security module 110 having a PUF 450. The security module 110 is arranged to establish a firmware key pair (FPK, FSK) based on a first challenge and response to the PUF and an enrolment key pair (EPK, ESK) based on a second challenge and response to the PUF. It is assumed that a public authority key PAK of an authority key pair is already embedded securely in the electronic device 100, for example, in the security module 110 of the electronic device. The authority key pair comprises the PAK and a corresponding secret authority key SAK. The method may be performed by, for example, one or more servers of an authority server system 130.

At 810, the method 800 comprises receiving, from a server, a hash of firmware over a secure communication channel, the firmware for installation on the electronic device 100. For example, an authority server may receive the encrypted firmware from a KMS 120 over a TLS connection as in FIG. 6A.

At 820, the method 800 comprises signing the hash of firmware using a secret authority key of an authority key pair comprising a public authority key (PAK) and the secret authority key (SAK), wherein the public authority key is embedded securely in the electronic device. Any suitable digital signature scheme may be utilized.

If an authority server system 130 performs the method 800, an authority server that signs the encrypted firmware may be the same or different to that authority server which performed step 810.

At 830, the method 800 comprises initiating communication of the signature over the hash of the firmware to a third party for installation on the electronic device. For example, the third party may comprise a programming house 180 or any entity beyond the authority server system 130 and the server (for example KMS 120) from which the encrypted firmware was received. For example, the server system 130 may communicate the signature to the KMS 120 for encryption and forwarding on to the third party (as in FIG. 6B), or may directly communicate the signature to the third party in unencrypted form.

At 840, the method 800 comprises sending to the server (e.g. KMS 120), over a secure communication channel, the FPK and an associated device identifier for identifying the electronic device 100, the device identifier comprising a function of the EPK. The FPK and device identifier may be provided to the server in a lookup table. The device identifier and FPK may have been obtained in any suitable way, for example by extracting them from the security module 110 prior to shipping to the OEM 160, or by receiving the information from another source. The step 830 may be performed before, simultaneously with, or subsequent to step 840.

The method may further comprise, after the electronic device has been programmed, receiving a request from the server to register the device identifier, and associating the server with the device identifier.

FIG. 8B shows a flowchart of a general method 850 for authenticating firmware for an electronic device 100. It is assumed that the electronic device 100 comprises a security module 110 having a PUF 450. The security module 110 is arranged to establish a firmware key pair (FPK, FSK) based on a first challenge and response to the PUF and an enrolment key pair (EPK, ESK) based on a second challenge and response to the PUF. It is assumed that a public authority key PAK of an authority key pair is already embedded securely in the electronic device 100, for example, in the security module 110 of the electronic device. The authority key pair comprises the PAK and a corresponding secret authority key SAK. The method may be performed by, for example, one or more servers of an authority server system 130.

At 860, the method 850 comprises receiving, from a server, encrypted firmware over a secure communication channel, the firmware for installation on the electronic device 100. For example, an authority server may receive the encrypted firmware from a KMS 120 over a TLS connection as in FIG. 6B.

At 870, the method 850 comprises signing the encrypted firmware using the secret authority key SAK of the authority key pair. Any suitable digital signature scheme may be utilized.

If an authority server system 130 performs the method 850, an authority server that signs the encrypted firmware may be the same or different to that authority server which performed step 860.

At 880, the method 850 comprises initiating communication of the signed encrypted firmware to a third party for installation on the electronic device. For example, the third party may comprise a programming house 180 or any entity beyond the authority server system 130 and the server (for example KMS 120) from which the encrypted firmware was received. For example, the server system 130 may communicate the signed encrypted firmware to the KMS 120 for forwarding on to the third party, or may directly communicate the signed encrypted firmware to the third party.

At 890, the method 850 comprises sending to the server (e.g. KMS 120), over a secure communication channel, the FPK and an associated device identifier for identifying the electronic device 100, the device identifier comprising a function of the EPK. The FPK and device identifier may be provided to the server in a lookup table. The device identifier and FPK may have been obtained in any suitable way, for example by extracting them from the security module 110 prior to shipping to the OEM 160, or by receiving the information from another source. The step 880 may be performed before, simultaneously with, or subsequent to step 890.

The method may further comprise, after the electronic device has been programmed, receiving a request from the server to register the device identifier, and associating the server with the device identifier.

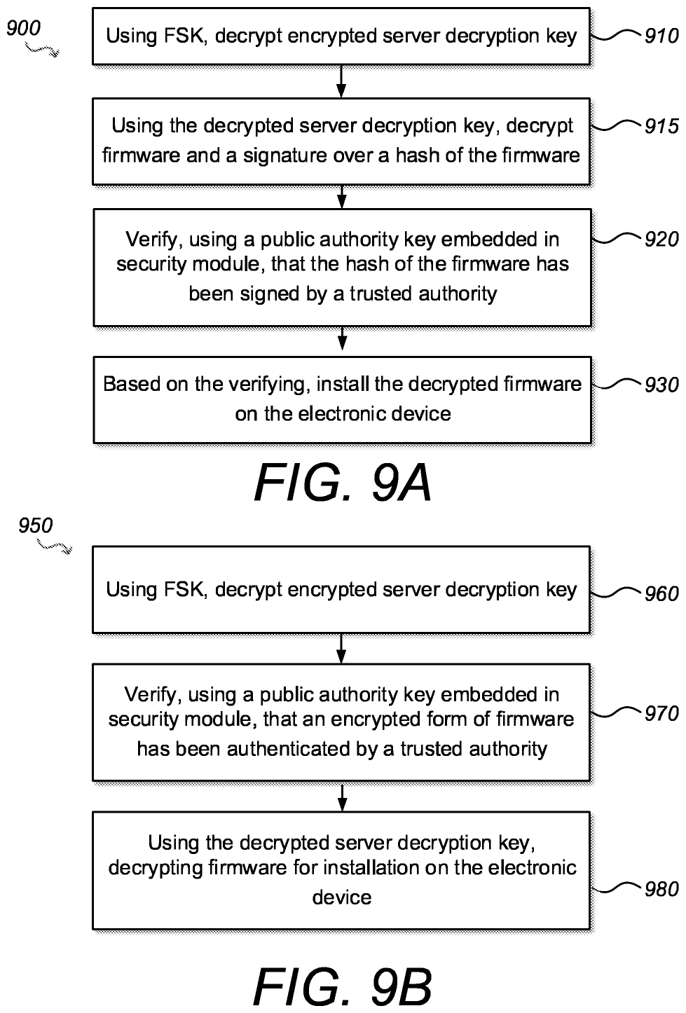

FIG. 9A shows a flowchart of a general method 900 for performance by an electronic device 100. The electronic device 100 comprises a security module 110 having a physical unclonable function (PUF) 450, the security module 110 configured to establish a firmware key pair (FPK, FSK) based on a first challenge and response to the PUF.

At 910, the method 900 comprises, using the FSK, decrypting an encrypted server decryption key, wherein the server decryption key is encrypted using the FPK.

At 915, the method 900 comprises using the decrypted server decryption key, decrypting firmware and a signature over a hash of the firmware.

At 920, the method 900 comprises verifying, using a public authority key embedded securely in the electronic device, that the hash of the firmware has been signed by a trusted authority such as authority 140. The public authority key is part of an authority key pair comprising the public authority key and a corresponding secret authority key in the possession of a trusted authority. Step 910 may be performed prior to, simultaneous with, or subsequent to step 920.

At 930, the method 900 comprises, based on the verifying, installing the decrypted firmware on the electronic device 100.

FIG. 9B shows another flowchart of a general method 950 for performance by the electronic device 100.

At 960, the method 950 comprises, using the FSK, decrypting an encrypted server decryption key, wherein the server decryption key is encrypted using the FPK.

At 970, the method 950 comprises verifying, using a public authority key embedded securely in the electronic device 100, that an encrypted form of firmware has been authenticated by a trusted authority such as authority 140. The public authority key is part of an authority key pair comprising the public authority key and a corresponding secret authority key in the possession of a trusted authority. Step 960 may be performed prior to, simultaneous with, or subsequent to step 970.

At 980, the method 950 comprises using the decrypted server decryption key to decrypt firmware for installation on the electronic device 100.

The methods described above in relation to FIGS. 6A-9B enable firmware to be securely provided to an electronic device. Advantageously, the firmware is not provided in unencrypted form to either the authority 140 or the programming house 180. Once an electronic device 100 has been provided with firmware, the electronic device can begin enrolment.

One or more root certificates may be installed on the electronic device 100 at the point of manufacture, or for added security may be provided to the electronic device 100 along with or as part of the firmware using the methods described above in relation to FIGS. 6-9.

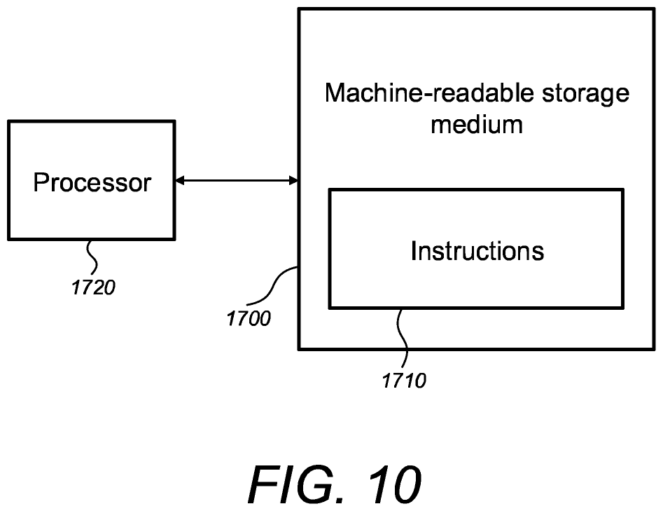

FIG. 10 illustrates a computer readable medium 1700 according to some examples.

The computer readable medium 1700 stores units, with each unit including instructions 1710 that, when executed, cause a processor 1720 or other processing/computing device or apparatus to perform particular operations.

For example, the instructions 1710 may cause a processor 1720 to cause a hash of the firmware to be signed using a secret key of a key pair comprising a public key and the secret key, wherein the public key is embedded securely in the electronic device. The instructions 1710 may further cause the processor 1720 to encrypt the firmware and the signature over the hash using a server encryption key. The instructions 1710 may further cause the processor 1720 to encrypt a server decryption key using the FPK, the server decryption key for decrypting the encrypted firmware and the encrypted signature. The instructions 1710 may further cause the processor 1720 to communicate the encrypted firmware, the encrypted signature, and the encrypted server decryption key to a third party for installation on the electronic device.

In another example, the instructions 1710 may cause a processor 1720 to cause an encrypted form of firmware to be signed using a secret key of an encryption key pair comprising a public key and the secret key, wherein the public key is embedded securely in an electronic device, and wherein the firmware is encrypted using a server encryption key. The instructions 1710 may further cause the processor 1720 to initiate communication of the signed encrypted form of the firmware to a third party for installation on the electronic device. The instructions 1710 may further cause the processor 1720 communicate an encrypted form of a server decryption key to the third party for installation on the electronic device, wherein the server decryption key is for decrypting the encrypted form of the firmware, and wherein the server decryption key is encrypted using a firmware public key, FPK.

For example, the instructions 1710 may cause a processor to sign a hash of the firmware using a secret authority key of an authority key pair comprising a public authority key and the secret authority key, wherein the public authority key is embedded in the security module of an electronic device, and wherein the hash of the firmware is received over a secure communication channel from a server. The instructions 1710 may further cause the processor 1720 to initiate communication of the signature over the hash of the firmware to a third party for installation on the electronic device. The instructions 1710 may further cause the processor 1720 to send, over a secure communication channel, a lookup table to the server, the lookup table indicating a firmware public key, FPK, and an associated device identifier for identifying the electronic device, the device identifier comprising a function of an enrolment public key, EPK.

In another example, the instructions 1710 may cause a processor to sign encrypted firmware using a secret authority key of an authority key pair comprising a public authority key and the secret authority key, wherein the public authority key is embedded in the security module of an electronic device, and wherein the encrypted firmware is received over a secure communication channel from a server. The instructions 1710 may further cause the processor 1720 to initiate communication of the signed encrypted firmware to a third party for installation on the electronic device. The instructions 1710 may further cause the processor 1720 to send, over a secure communication channel, a lookup table to the server, the lookup table indicating a firmware public key, FPK, and an associated device identifier for identifying the electronic device, the device identifier comprising a function of an enrolment public key, EPK.

For example, the instructions 1710 may cause a processor 1720 to, using a firmware secret key, FSK, decrypt an encrypted server decryption key, wherein the server decryption key is encrypted using the firmware public key FPK. The instructions 1710 may further cause a processor 1720 to, using the decrypted server decryption key, decrypt encrypted firmware and a signature over a hash of the firmware. The instructions 1710 may further cause a processor 1720 to verify, using a public authority key embedded securely in the electronic device, that the hash of the firmware has been signed by a trusted authority. The instructions 1710 may further cause a processor 1720 to, based on the verifying, install the decrypted firmware on the electronic device.

For example, the instructions 1710 may cause a processor 1720 to, using a firmware secret key, FSK, decrypt an encrypted server decryption key, wherein the server decryption key is encrypted using a firmware public key, FPK, which together with the FSK forms a firmware key pair. The instructions 1710 may further cause a processor 1720 to verify, using a public authority key, that an encrypted form of firmware has been authenticated by a trusted authority. The instructions 1710 may further cause a processor 1720 to, using the decrypted server decryption key, decrypt firmware for installation on the electronic device.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Many variations of the methods described herein will be apparent to the skilled person.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method for providing firmware to an electronic device, the electronic device comprising a security module having a physical unclonable function (PUF), the security module configured to establish a firmware key pair (FPK, FSK) based on a first challenge and response to the PUF, the firmware key pair comprising a firmware public key (FPK) and a firmware secret key (FSK), wherein the method comprises:
causing a hash of the firmware to be signed using a secret key of an authority key pair to obtain a signature, wherein the authority key pair comprises a public key and the secret key, wherein the public key is embedded securely in the electronic device;
encrypting the firmware and the signature using a server encryption key;
encrypting a server decryption key using the FPK, the server decryption key for decrypting the encrypted firmware and the encrypted signature;
communicating the encrypted firmware, the encrypted signature, and the encrypted server decryption key to a third party for installation on the electronic device.

2. A method according to claim 1, the method further comprising receiving the firmware and performing a hash function on the firmware to generate the hash of the firmware.

3. A method according to claim 1, wherein the method further comprises receiving the hash of the firmware.

4. A method according to any preceding claim, wherein causing a hash of the firmware to be signed comprises signing the hash of the firmware.

5. A method according to any of claims 1-3, wherein causing a hash of the firmware to be signed comprises transmitting the hash of the firmware to a trusted authority, and receiving the signature from the trusted authority.

6. A method according to any preceding claim, the method further comprising receiving the FPK from a trusted authority.

7. A method according to any preceding claim, wherein the server encryption key is the same as the server decryption key.

8. A method according to any preceding claim,
wherein the security module is further configured to establish an enrolment key pair (EPK, ESK) based on a second challenge and response to the PUF, the enrolment key pair comprising an enrolment public key (EPK) and an enrolment secret key (ESK); and
wherein the method further comprises communicating a device identifier to the third party, the device identifier comprising a function of the EPK.

9. A method according to claim 8, wherein the device identifier is received from a trusted authority.

10. A method according to any preceding claim, the method further comprising:
after the firmware has been installed on the electronic device, receiving the device identifier and registering the device identifier with the trusted authority.

11. A computer readable medium having instructions stored thereon which, when executed by one or more processors, cause the one or more processors to perform the method of any preceding claim.

12. Computing apparatus comprising:
one or more processors; and
one or more memories having instructions stored thereon which, when executed by the one or more processors, cause the one or more processors to execute a method according to any of claims 1-10.

13. A method for authenticating firmware for an electronic device, the electronic device comprising a security module having a physical unclonable function (PUF), the security module configured to establish a firmware key pair (FPK, FSK) based on a first challenge and response to the PUF and an enrolment key pair (EPK, ESK) based on a second challenge and response to the PUF, wherein the firmware key pair comprises a firmware public key (FPK) and a firmware secret key (FSK), and wherein the enrolment key pair (EPK, ESK) comprises an enrolment public key (EPK) and an enrolment secret key (ESK), the method comprising:
receiving, from a server, a hash of firmware over a secure communication channel, the firmware for installation on the electronic device;
signing the hash of the firmware using a secret authority key of an authority key pair comprising a public authority key (PAK) and the secret authority key (SAK), wherein the public authority key is embedded securely in the electronic device;
initiating communication of the signature over the hash to a third party for installation on the electronic device; and
sending, over a secure communication channel to the server, the FPK and an associated device identifier for identifying the electronic device, the device identifier comprising a function of the EPK.

14. A method according to claim 13, the method further comprising extracting the device identifier from the security module.

15. A method according to claim 13 or claim 14, the method further comprising extracting the FPK from the security module.

16. A method according to claim 13 or claim 14, the method further comprising receiving the device identifier and the FPK.

17. A method according any of claims 13 to 16, the method further comprising receiving a request to register the device identifier with the server.

18. A method according to any of claims 13 to 17, the method further comprising entering the device identifier and the FPK in a lookup table.

19. A computer readable medium having instructions stored thereon which, when executed by one or more processors, cause the one or more processors to perform the method of any of claims 13 to 18.

20. Computing apparatus comprising:
one or more processors; and
one or more memories having instructions stored thereon which, when executed by the one or more processors, cause the one or more processors to execute a method according to any of claims 13-18.

21. A method for performance by an electronic device, the electronic device comprising a security module having a physical unclonable function (PUF), the security module configured to establish a firmware key pair (FPK, FSK) based on a first challenge and response to the PUF, the firmware key pair comprising a firmware public key (FPK) and a firmware secret key (FSK), wherein the method comprises:
using the FSK, decrypting an encrypted server decryption key, wherein the server decryption key is encrypted using the FPK;
using the decrypted server decryption key, decrypting firmware and a signature over a hash of the firmware;
verifying, using a public authority key embedded securely in the electronic device, that the hash of the firmware has been signed by a trusted authority; and
based on the verifying, installing the decrypted firmware on the electronic device.

22. A method according to claim 21, further comprising, on booting, verifying that the firmware has been signed by a trusted party.

23. An electronic device comprising:
a security module having a physical unclonable function (PUF), the security module configured to establish a firmware key pair (FPK, FSK) based on a first challenge and response to the PUF, the firmware key pair comprising a firmware public key (FPK) and a firmware secret key (FSK);
one or more processors comprising or communicatively coupled to the security module, wherein the one or more processors are configured to:
use the FSK to decrypt an encrypted server decryption key, wherein the server decryption key is encrypted using the FPK;
use the decrypted server decryption key to decrypt firmware and a signature over a hash of the firmware;
verify, using a public authority key embedded securely in the electronic device, that the hash of the firmware has been signed by a trusted authority; and
based on the verifying, install the decrypted firmware on the electronic device.

24. A system for providing firmware to an electronic device, the electronic device comprising a security module having a physical unclonable function (PUF), the security module configured to establish a firmware key pair (FPK, FSK) based on a first challenge and response to the PUF, wherein the firmware key pair comprises a firmware public key (FPK) and a firmware secret key (FSK), the system comprising a trusted authority and a server,
wherein the trusted authority is configured to:
receive a hash of firmware from the server;
sign the hash of the firmware using a secret authority key of an authority key pair comprising a public authority key and the secret authority key, wherein the public authority key is embedded securely in the electronic device;
send the signature over the hash of the firmware to the server; and
send the FPK to the server; and
wherein the server is configured to:
receive the signature from the trusted authority;
receive the FPK from the trusted authority;
encrypt the firmware and the signature using a server encryption key;
encrypt a server decryption key using the FPK, the server decryption key for decrypting the encrypted firmware and the encrypted signature;
communicating the encrypted firmware, the encrypted signature, and the encrypted server decryption key to a third party for installation on the electronic device.
